(19) United States
(12) Patent Application Publication
(10) Pub. No.: US 2026/0285385 A1
(43) Pub. Date: Sep. 24, 2026

(54) FRAME, SEAT LOCKING DEVICE, AND STROLLER

(71) Applicant: WONDERLAND SWITZERLAND AG, Steinhausen (CH)

(72) Inventor: Haitao WU, Dongguan (CN)

(21) Appl. No.: 19/475,347

(22) PCT Filed: Apr. 12, 2024
(86) PCT No.: PCT/EP2024/060007

§ 371 Date: Oct. 14, 2025

(30) Foreign Application Priority Data
Apr. 14, 2023 (CN) 202310405158.6
Apr. 14, 2023 (CN) 202310405480.9
Apr. 8, 2024 (CN) 202410418812.1

(51) Int. Cl. B62B 7/06; B62B 7/08; B62B 7/14; B62B 9/20

(52) U.S. Cl. CPC B62B 7/062; B62B 7/083; B62B 7/142; B62B 7/145; B62B 9/20; B62B 2205/18; B62B 2205/22; B62B 2206/04; B62B 2206/06

(57) ABSTRACT

A stroller is disclosed. The stroller includes a frame. The frame includes: a first wheel frame including a first support assembly; a second wheel frame including a second support assembly; a push rod frame including a push rod assembly; and a folding mechanism including a linkage assembly and a rotating shaft. The first support assembly, the second support assembly, and the push rod assembly are pivotally connected through the rotating shaft. The first support assembly and the second support assembly are capable of being rotated and folded relative to the push rod assembly through the linkage assembly.

### CROSS-REFERENCE TO RELATED APPLICATIONS

This application is an U.S. national phase application under 35 U.S.C § 371 based upon international patent application No. PCT/EP2024/060007 filed on Apr. 12, 2024, which itself claims priority to Chinese patent application No. 2023104054809, filed on Apr. 14, 2023, Chinese patent application No. 2023104051586, filed on Apr. 14, 2023, and Chinese patent application No. 2024104188121, filed on Apr. 8, 2024, and the content of which are hereby incorporated by reference in their entireties.

### TECHNICAL FIELD

The present application relates to the technical field of child carriers, and in particular, to a frame, a seat locking device, and a stroller.

### BACKGROUND

At present, strollers with a high field of vision are becoming more and more popular among consumers. Such strollers can provide children with a better viewing field. However, it is inconvenient to fold the overall frame of this kind of stroller with a high field of vision. In addition, in order to improve children's riding experience, a seat of this kind of stroller needs to be reversible forward or backward. In addition, in order to meet the needs of cleaning, storage or transportation, the seat and frame of the stroller also need to be detachable. At present, the strollers usually have a problem that the reversing structure for reversing the seat forward or backward is complex and inconvenient to operate.

### SUMMARY

According to various embodiments of the present application, a frame, a seat locking device, and a stroller are provided.

According to an aspect of the present application, a stroller is provided. The stroller includes a frame. The frame includes: a first wheel frame including a first support assembly; a second wheel frame including a second support assembly; a push rod frame including a push rod assembly; and a folding mechanism including a linkage assembly and a rotating shaft. The first support assembly and the second support assembly, and the push rod assembly are pivotally connected through the rotating shaft. The first support assembly and the second support assembly are capable of being rotated and folded relative to the push rod assembly through the linkage assembly. The linkage assembly includes: a first linking rod, a first end of the first linking rod being rotatably connected to the push rod assembly; a second linking rod, a first end of the second linking rod being rotatably connected to a second end of the first linking rod, and a second end of the second linking rod being rotatably connected to the first support assembly; and a third linking rod, a first end of the third linking rod being rotatably connected to the second end of the first linking rod, and a second end of the third linking rod being rotatably connected to the second support assembly.

In an embodiment, the push rod frame includes a handle assembly, the folding mechanism further includes an unlocking assembly drivingly connected to the handle assembly. The handle assembly is operable to drive the unlocking assembly to be unlocked, so that the first support assembly and the second support assembly are capable of being rotated and folded relative to the push rod assembly through the linkage assembly.

According to another aspect of the present application, a frame is provided. The frame includes: a first wheel frame; a second wheel frame; a push rod frame pivotally connected to the first wheel frame and the second wheel frame, and including a handle assembly; and a folding mechanism including an unlocking assembly pivotally connected to the handle assembly. The handle assembly is operable to drive the unlocking assembly to be unlocked, so that the first wheel frame, the second wheel frame, and the push rod frame are rotated and folded by the folding mechanism.

In an embodiment, the first wheel frame includes a first support assembly; the second wheel frame includes a second support assembly. The push rod frame includes a push rod assembly. The first support assembly and the second support assembly, and the push rod assembly are pivotally connected by a rotating shaft. The folding mechanism includes a linkage assembly. The first support assembly and the second support assembly are movably connected to the push rod assembly through the linkage assembly. The first support assembly and the second support assembly are capable of being rotated and folded relative to the push rod assembly through the linkage assembly.

In an embodiment, the linkage assembly includes: a first linking rod, a first end of the first linking rod being rotatably connected to the push rod assembly; a second linking rod, a first end of the second linking rod being rotatably connected to a second end of the first linking rod, and a second end of the second linking rod being rotatably connected to the first support assembly; and a third linking rod, a first end of the third linking rod being rotatably connected to the second end of the first linking rod, and a second end of the third linking rod being rotatably connected to the second support assembly.

In an embodiment, the linkage assembly includes: a sun gear fixed to the push rod assembly; a rotary plate fixed to the first support assembly and including a first guide groove, the first guide groove including a toothed edge; a planetary gear engaged with the sun gear and the toothed edge; and a driving shaft arranged eccentrically with respect to the rotating shaft. The driving shaft extends through the second support assembly, the planetary gear, and the push rod assembly. The second support assembly is pivotally connected to the push rod assembly by the driving shaft.

In an embodiment, the driving shaft is fixedly connected to the second support assembly and the planetary gear, and rotatable relative to the push rod assembly.

In an embodiment, the toothed edge is arc-shaped, and is arranged along a circumferential direction of the rotary plate.

In an embodiment, the toothed edge includes a first end and a second end, for limiting movement of the planet gear between the first end and the second end.

In an embodiment, the first support assembly includes a first rotating base. The second support assembly includes a second rotating base. The push rod assembly includes a pivot base. The first rotating base, the second rotating base and the pivot base are pivotally connected through the rotating shaft.

In an embodiment, the first wheel frame includes two first support assemblies opposite to each other. The second wheel frame includes two second support assemblies opposite to each other. The push rod frame includes a push rod assembly. The two first support assemblies, the two second support assemblies, and the push rod assembly are pivotally connected by a rotating shaft. The folding mechanism includes two linkage assemblies. Each first support assembly and each second support assembly are movably connected to the push rod assembly by the respective linkage assembly. Each first support assembly and each second support assembly are capable of being rotated and folded relative to the push rod assembly by the respective linkage assembly.

In an embodiment, each first support assembly includes a first rotating base. Each second support assembly includes a second rotating base. The push rod assembly includes a pivot base. Two first rotating bases are pivotally connected to two sides of the pivot base respectively. Two second rotating bases are pivotally connected to sides of the two first rotating bases away from the pivot base by a rotating shaft respectively.

In an embodiment, the first support assembly includes a first rotating base including a locking recess. The unlocking assembly includes a locking member. When the locking member is in a locked state, the locking member is inserted into the locking recess, so that the push rod assembly and the first support assembly are fixed relative to each other; when the unlocking assembly is in an unlocked state, the locking member is separated from the locking recess so that the push rod assembly is rotatable relative to the first support assembly.

In an embodiment, the unlocking assembly further includes: a driving member disposed on the push rod assembly, and drivingly connected to the handle assembly; and a pulling member, two ends of the pulling member being connected to the driving member and the locking member respectively. The handle assembly is operable to drive the driving member to move, and drive the locking member to be separated from the locking recess by the pulling member.

In an embodiment, the handle assembly includes a handle body and a handle part rotatably disposed on the handle body. The driving member is connected to the handle part and is rotatable with the handle part.

In an embodiment, the unlocking assembly further includes a first reset member. Two ends of the first reset member abut against the locking member and the push rod assembly respectively. The first reset member is adapted to bias the locking member to move towards a direction of being inserted into the locking recess.

In an embodiment, the unlocking assembly further includes a safety unlocking member movable between a first position and a second position. When the safety unlocking member is in the first position, the handle part is unable to drive the driving member to move when being operated; when the safety unlocking member is in the second position, the handle part is able to drive the driving member to move when being operated.

In an embodiment, the unlocking assembly further includes a limiting member movably disposed on the push rod frame. When the safety unlocking member is in the first position, the limiting member limits a movement of the driving member; when the safety unlocking member is in the second position, the limiting member does not limit the movement of the driving member, and the safety unlocking member is operable to move from the first position to the second position.

In an embodiment, the unlocking assembly further includes a second reset member. Two ends of the second reset member abut against the driving member and the limiting member respectively. The second reset member is adapted to bias the limiting member to move towards a direction of limiting the movement of the driving member.

In an embodiment, the handle assembly includes two handle parts and a handle body. The two handle parts are rotatably disposed on the handle body. The unlocking assembly further includes: two driving members both disposed on the push rod frame and drivingly connected to the two handle parts respectively; and two pulling members, two ends of each pulling member being respectively connected to one of the driving members and one of the locking members. Any of the handle parts is operable to drive the corresponding driving member to move, and drives the locking member to be separated from the locking recess by the corresponding pulling member.

In an embodiment, the unlocking assembly further includes a safety unlocking member movable between a first position and a second position. Two second positions are provided, and the first position is located on between the two second positions. When the safety unlocking member is in the first position, neither of the handle parts drives the driving member to move when being operated, and when the safety unlocking member is in any of the second positions, one of the handle parts drives the driving member to move when being operated.

In an embodiment, the unlocking assembly further includes two limiting members movably disposed on the push rod frame. When the safety unlocking member is in the first position, the two limiting members respectively limit movement of the two driving members; when the safety unlocking member is in any of the second positions, one of the limiting members does not limit the movement of one of the driving members, and the safety unlocking member is operable to move from the first position to the second position.

In an embodiment, the unlocking assembly further includes two second reset members. Two ends of each second reset member abut against one of the driving members and one of the limiting members respectively. Each second reset member is adapted to bias the corresponding limiting member to move towards a direction of limiting the movement of the corresponding driving member.

According to another aspect of the present application, a stroller is provided. The stroller includes: the frame as described in any of the above embodiments; and a seat frame disposed on the push rod frame; and a seat assembly disposed on the seat frame.

In an embodiment, the push rod frame includes a push rod assembly; the seat frame is movable along the push rod assembly; and the stroller further includes a seat height adjustment mechanism disposed between the push rod frame and the seat frame. The seat height adjustment mechanism has a locked state and an unlocked state. When the seat height adjustment mechanism is in the locked state, the seat frame and the push rod assembly are fixed relative to each other; when the seat height adjustment mechanism is in the unlocked state, the seat frame is movable relative to the push rod assembly so that a height of the seat assembly is adjustable.

In an embodiment, the stroller further includes a seat height adjustment mechanism disposed between the push rod frame and the seat frame. The seat height adjustment mechanism includes: a plurality of first locking holes disposed in the push rod assembly; and a first locking pin disposed on the seat frame, and the first locking pin being movable between a third position and a fourth position. The first locking pin is inserted into one of the first locking holes when being in the third position, and the first locking pin is separated from the first locking hole when being in the fourth position.

In an embodiment, the seat height adjustment mechanism further includes a height adjustment operating member. The height adjustment operating member includes: a pivot end pivotally connected to the first locking pin; and an operating end operable to drive the first locking pin to move towards the fourth position by the pivot end.

In an embodiment, the seat height adjustment mechanism further includes a third reset member. Two ends of the third reset member abut against the height adjustment operating member and the seat frame respectively. The third reset member is adapted to bias the height adjustment operating member to drive the first locking pin to move toward the third position.

In an embodiment, the push rod frame includes a push rode assembly, and a length of the push rod assembly is adjustable.

In an embodiment, the stroller further includes a length adjustment mechanism. The push rod assembly includes a first push rod and a second push rod. The first push rod is at least partially inserted into the second push rod. The length adjustment mechanism includes: a plurality of second locking holes disposed on the second push rod; and a second locking pin disposed on the first push rod and movable between a fifth position and a sixth position. When the second locking pin is in the fifth position, the second locking pin is inserted into one of the second locking holes, and when the second locking pin is in the sixth position, the second locking pin is separated from the second locking hole.

In an embodiment, the length adjustment mechanism includes a length adjustment operating member disposed on the first push rod and drivingly connected to the second locking pin. The length adjustment operating member is operable to drive the second locking pin to move towards the sixth position.

In an embodiment, the length adjustment mechanism includes a fourth reset member being adapted to bias the second locking pin to move toward the fifth position.

In an embodiment, the seat assembly is rotatable relative to the seat frame.

In an embodiment, the stroller further includes: a connecting base disposed on the seat assembly and movably connected to the seat frame, the connecting base having a first moving position and a second moving position, and where when the connecting base is in the first moving position, the connecting base is not rotatable relative to the seat frame, and when the connecting base is in the second moving position, the connecting base is rotatable relative to the seat frame; and a first locking mechanism switchable between an unlocked state and a locked state. When the first locking mechanism is in the unlocked state, the connecting base is movable between the first moving position and the second moving position relative to the seat frame; when the first locking mechanism is in the locked state, the connecting base is not movable relative to the seat frame.

In an embodiment, the seat frame is provided with a guide rail, and a first guide groove is disposed on a side of the connecting base facing the seat frame. The connecting base is capable of moving along the guide rail between the first moving position and the second moving position through an engagement between the first guide groove with the guide rail. When the connecting base is in the first moving position, the first guide groove is engaged with the guide rail, so that the connecting base is not rotatable relative to the seat frame; when the connecting base is in the second moving position, the first guide groove is disengaged from the guide rail, so that the connecting base is rotatable relative to the seat frame.

In an embodiment, the first locking mechanism includes a reversing unlocking member operably disposed between the seat frame and the connecting base. The reversing unlocking member is switchable between a reversal unlocked position and a reversal locked position. When the reversing unlocking member is in the reversal locked position, the reversing unlocking member abuts against the guide rail, so that the reversing unlocking member is not movable along the guide rail, and limits a movement of the connecting base along the guide rail; when the reversing unlocking member is in the reversing unlocked position, the reversing unlocking member is movable along the guide rail, so that the connecting base is movable relative to the seat frame.

In an embodiment, the guide rail includes a switching notch. When the connecting base is in the first moving position, the reversing unlocking member is inserted into the switching notch, and the reversing unlocking member moves relative to the guide rail in a direction intersecting with an extending direction of the guide rail to switch between the reversing unlocked position and the reversing locked position.

In an embodiment, the reversing unlocking member includes a strip-shaped positioning groove. The first locking mechanism further includes a positioning pin. The positioning pin is capable of being inserted into the positioning groove, so that the reversing unlocking member is movable relative to the positioning pin in a direction intersecting with an extending direction of the guide rail, and is movable along the extending direction of the guide rail in synchronization with the positioning pin.

In an embodiment, the first locking mechanism further includes a reversing reset member adapted to bias the reversing unlocking member to moves towards the reversing locked position.

In an embodiment, the stroller further includes a moving reset member adapted to bias the connecting base to move toward the first moving position.

In an embodiment, the stroller further includes a moving reset member and a movable post. The movable post is connected between the connecting base and the seat frame, and is movable relative to the seat frame. The moving reset member is connected to the movable post and the seat frame respectively. The moving reset member is adapted to bias the movable post to drive the connecting base to move towards the first moving position.

In an embodiment, the guide rail is provided with a rotation notch configured for the connecting base to rotate. When the connecting base is in the second moving position, the first guide groove is located at the rotation notch so that the connecting base is rotatable relative to the seat frame.

In an embodiment, the stroller further includes a movable base. The connecting base is connected to the seat frame by the movable base. When the first locking mechanism is in the unlocking state, the movable base is movable relative to the seat frame and drives the connecting base to move between the first moving position and the second moving position, so that when the connecting base is in the second moving position, the connecting base is rotatable relative to the seat frame; when the first locking mechanism is in the locked state, the movable base is fixed relative to the seat frame.

In an embodiment, the stroller further includes a movable base. The connecting base is connected to the seat frame by the movable base. The movable base is provided with a second guide groove capable of being engaged with the guide rail. When the first locking mechanism is in the unlocked state, the movable base is movable along the guide rail through an engagement between the second guide groove and the guide rail, and drives the connecting base to move between the first moving position and the second moving position; when the first locking mechanism is in the locked state, the movable base is fixed relative to the seat frame.

According to yet another aspect of the present application, a frame is provided. The frame includes: a first wheel frame including a first support assembly; a second wheel frame including a second support assembly; a push rod frame including a push rod assembly; and a folding mechanism including a linkage assembly and a rotating shaft. The first support assembly and the second support assembly, and the push rod assembly are pivotally connected through the rotating shaft. The first support assembly and the second support assembly are capable of being rotated and folded relative to the push rod assembly through the linkage assembly. The linkage assembly includes: a sun gear fixed to the push rod assembly; a rotary plate fixed to the first support assembly and including a first guide groove, the first guide groove including a toothed edge; a planetary gear engaged with the sun gear and the toothed edge; and a driving shaft arranged eccentrically with respect to the rotating shaft, the driving shaft extending through the second support assembly, the planetary gear, and the push rod assembly, and wherein the second support assembly is pivotally connected to the push rod assembly by the driving shaft.

According to yet another aspect of the present application, a seat locking device is provided. The seat locking device is configured to connecting a frame and a seat assembly, and includes: a seat frame connected to the frame; a connecting base disposed on the seat assembly and movably connected to the seat frame. The connecting base has a first moving position and a second moving position; when the connecting base is in the first moving position, the connecting base is not rotatable relative to the seat frame; and when the connecting base is in the second moving position, the connecting base is rotatable relative to the seat frame.

In an embodiment, the seat locking device further includes a first locking mechanism switchable between an unlocked state and a locked state. When the first locking mechanism is in the unlocked state, the connecting base is movable between the first moving position and the second moving position relative to the seat frame; and when the first locking mechanism is in the locked state, the connecting base is not movable relative to the seat frame.

In an embodiment, the seat frame is provided with a guide rail, and a surface of the connecting base facing the seat frame is provided with a first guide groove capable of being engaged with the guide rail. The connecting base is movable along the guide rail between the first moving position and the second moving position. When the connecting base is in the first moving position, the first guide groove is engaged with the guide rail, so that the connecting base is not rotatable relative to the seat frame; when the connecting base is in the second moving position, the first guide groove is disengaged from the guide rail, so that the connecting base is rotatable relative to the seat frame.

In an embodiment, the seat locking device further includes a first locking mechanism. The first locking mechanism includes a reversing unlocking member operably disposed between the seat frame and the connecting base, and switchable between a reversal unlocked position and a reversal locked position. When the reversing unlocking member is in the reversal locked position, the reversing unlocking member abuts against the guide rail, so that the reversing unlocking member is not movable along the guide rail, and limits a movement of the connecting base along the guide rail; when the reversing unlocking member is in the reversing unlocked position, the reversing unlocking member is movable along the guide rail, so that the connecting base is movable relative to the seat frame.

In an embodiment, the guide rail includes a switching notch. When the connecting base is in the first moving position, the reversing unlocking member is inserted into the switching notch, and moves relative to the guide rail in a direction intersecting with an extending direction of the guide rail to switch between the reversing unlocked position and the reversing locked position.

In an embodiment, the reversing unlocking member includes a reversing operating part extending out of the connecting base.

In an embodiment, the reversing unlocking member includes a strip-shaped positioning groove. The first locking mechanism further includes a positioning pin. The positioning pin is capable of being inserted into the positioning groove so that the reversing unlocking member is movable relative to the positioning pin in a direction intersecting with the extending direction of the guide rail, and movable in the extending direction of the guide rail in synchronization with the positioning pin.

In an embodiment, the first locking mechanism further includes a reversing reset part being adapted to bias the reversing unlocking member to move towards the reversing locked position.

In an embodiment, the seat locking device further includes a moving reset member adapted to bias the connecting base to move toward the first moving position.

In an embodiment, the seat locking device further includes a moving reset member and a movable post. The movable post is connected between the connecting base and the seat frame, and is movable relative to the seat frame; and the moving reset member is connected to the movable post and the seat frame respectively; the moving reset member is adapted to bias the movable post to drive the connecting base to move towards the first moving position.

In an embodiment, the movable post is arranged offset from a rotation axis of the connecting base.

In an embodiment, the seat frame includes a third receiving groove. A portion of the movable post and the moving reset member are received in the third receiving groove.

In an embodiment, the guide rail is provided with a rotation notch configured for the connecting base to rotate; and when the connecting base is in the second moving position, the first guide groove is located at the rotation notch so that the connecting base is rotatable relative to the seat frame.

In an embodiment, the guide rail includes a first section and a second section, and the rotation notch is formed between the first section and the second section. When the connecting base is in the second moving position, the first guide groove is located at the rotation notch so that the connecting base is rotatable relative to the seat frame; when the connecting base is in the first moving position, at least a portion of the first guide groove is engaged with the first section, so that the connecting base is not rotatable relative to the seat frame.

In an embodiment, the seat locking device further includes a first locking mechanism and a movable base. The connecting base is connected to the seat frame by the movable base. When the first locking mechanism is in the unlocked state, the movable base is movable relative to the seat frame and drives the connecting base to move between the first moving position and the second moving position, so that when the connecting base is in the second moving position, the connecting base is rotatable relative to the seat frame; when the first locking mechanism is in the locked state, the movable base is fixed relative to the seat frame.

In an embodiment, the seat frame is provided with a guide rail, and the movable base is provided with a second guide groove capable of being engaged with the guide rail. When the first locking mechanism is in the unlocking state, the movable base is movable along the guide rail through an engagement between the second guide groove and the guide rail, and drives the connecting base to move between the first moving position and the second moving position; and when the first locking mechanism is in the locked state, the movable base is fixed relative to the seat frame.

In an embodiment, the seat locking device further includes a movable base and a second locking mechanism. The connecting base is connected to the seat frame by the movable base, and is detachably connected to the movable base by the second locking mechanism.

In an embodiment, the movable base is provided with an engaging groove. The second locking mechanism includes a separation locking member. The separation locking member is movably disposed on the connecting base and includes a hook part. The separation locking member is switchable between a separation locked position and a separation unlocked position. When the separation locking member is in the separation locked position, the hook part is engaged with the engaging groove, and when the separation locking member is in the separation unlocked position, the hook part is disengaged from the engaging groove.

In an embodiment, the second locking mechanism further includes a separation unlocking member drivingly connected to the separation locking member. The separation unlocking member is operable to drive the separation locking member to switch from the separation locked position to the separation unlocked position.

In an embodiment, the separation locking member includes a first separation locking member. One of the first separation locking member and the separation unlocking member is provided with a first protrusion, another of the first separation locking member and the separation unlocking member is provided with a first driving groove. The first protrusion is inserted into and cooperates with the first driving groove to drive the first separation locking member to move between the separation locked position and the separation unlocked position. An extending direction of the first driving groove is parallel to a moving direction of the separation unlocking member.

In an embodiment, the separation locking member includes a second separation locking member provided with a locking driving surface; and the separation unlocking member is provided with an unlocking driving surface. the unlocking driving surface is capable of abutting against the locking driving surface to drive the second separation locking member to switch between the separation locked position and the separation unlocked position. An extending direction of the unlocking driving surface intersects with a moving direction of the separation unlocking members.

In an embodiment, the second separation locking member is provided with a second protrusion; a side surface of the second protrusion forms the locking driving surface. The separation unlocking member is provided with a second driving groove, and a groove wall of the second driving groove forms the unlocking driving surface. The second protrusion is inserted into the second driving groove so that the locking driving surface is capable of abutting against the unlocking driving surface.

In an embodiment, two separation unlocking members are provided, and the two separation unlocking members are symmetrically distributed with respect to a rotation axis of the connecting base. Two first separation locking members are provided, and the two first separation locking members are symmetrically distributed with respect to the rotation axis of the connecting base.

In an embodiment, two separation unlocking members are provided, and the two separation unlocking members are symmetrically distributed with respect to a rotation axis of the connecting base. Two or a multiple of two first separation locking members are provided. Each two second separation locking members are symmetrically distributed with respect to the rotation axis of the connecting base, and each second separation locking member is arranged at an angle with the adjacent separation locking member.

In an embodiment, each second separation locking member is arranged at a right angle to the adjacent separation unlocking member.

In an embodiment, two second separation locking members are provided. The two second separation locking members are symmetrically distributed with respect to a rotation axis of the connecting base. The locking driving surface of each second separation locking member includes a first locking driving surface and a second locking driving surface. The separation unlocking member includes a first separation unlocking member and a second separation unlocking member that are symmetrically distributed with respect to the rotation axis of the connecting base. The unlocking driving surface includes a first unlocking driving surface and a second unlocking driving surface. The first separation unlocking member is provided with two first unlocking driving surfaces. Each first unlocking driving surface abuts against the corresponding first locking driving surface of the second separation locking member. The second separation unlocking member is provided with two second unlocking driving surfaces, so that each second unlocking driving surface abuts against the corresponding second locking driving surfaces of the second separation locking member.

In an embodiment, the connecting base includes: a first housing including a first groove configured for receiving the movable base; and a second housing connected to the seat frame. The first housing and the second housing enclose a receiving chamber. The connecting base further includes a first opening. The first groove is in communication with the receiving chamber via the first opening. The separation locking member is at least partially received in the receiving chamber. The hook part of the separation locking member is capable of extending into the first groove via the first opening to be engaged with the engaging groove.

In an embodiment, the separation unlocking member includes a separation operating part and a separation driving part. The connecting base includes a receiving chamber and a second opening extending through a sidewall of the receiving chamber. The separation driving member is located in the receiving chamber and is drivingly connected to the separation locking member. The separation operating part extends out of the receiving chamber via the second opening.

In an embodiment, one of the movable base and the connecting base is provided with a first insertion hole, and another of the movable base and the connecting base is provided with a connecting shaft. The connecting shaft is capable of being inserted into the first insertion hole.

In an embodiment, the second locking mechanism further includes a separation reset member disposed between the separation locking member and the connecting base. The separation reset member is adapted to bias the separation locking member to move toward the separation locked position.

In an embodiment, the movable base includes a truncated cone part and a disc-shaped part disposed at an end surface of the truncated cone part. The engaging groove is formed between the disc-shaped part and the truncated cone part.

In an embodiment, the separation locking member further includes a wedge-shaped surface disposed on the hook part. The wedge-shaped surface is adapted to be pushed by the movable base to drive the separation locking member to move.

According to still another aspect of the present application, a stroller is provided. The stroller includes: a seat assembly; a frame; and the seat locking device as described in any of the above embodiments. The seat assembly is connected to the frame by the seat locking device.

### BRIEF DESCRIPTION OF THE DRAWINGS

FIG. 1 is a schematic view of a stroller according to an embodiment of the present application, with a seat assembly in a forward unfolding state.

FIG. 2 is another schematic view of the stroller shown in FIG. 1, with the seat assembly in a backward unfolded state.

FIG. 3 is another schematic view of the stroller shown in FIG. 1, with the seat assembly in a folded state.

FIG. 4 is an exploded view of the stroller shown in FIG. 1.

FIG. 5 is an enlarged view of portion A in FIG. 4.

FIG. 6 is an exploded view of a linkage assembly and a portion of a frame shown in FIG. 5.

FIG. 7 is an exploded view of the linkage assembly and a portion of the frame shown in FIG. 5 from another perspective.

FIG. 8 is a cross-sectional view of a push rod frame and a seat frame of the stroller shown in FIG. 1.

FIG. 9 is an enlarged view of portion B in FIG. 8.

FIG. 10 is an enlarged view of portion C in FIG. 8.

FIG. 11 is a schematic view of the push rod frame and a portion of an unlocking assembly of the stroller shown in FIG. 1.

FIG. 12 is a partial cross-sectional view of the structure of FIG. 11.

FIG. 13 is another partial cross-sectional view of the structure of FIG. 11.

FIG. 14 is a partial cross-sectional view of the structure of FIG. 5.

FIG. 15 is an enlarged view of portion D of FIG. 8.

FIG. 16 is a partial cross-sectional view of a push rod frame of the stroller shown in FIG. 1

FIG. 17 is an enlarged view of portion E of FIG. 8.

FIG. 18 is a schematic view of a stroller according to another embodiment of the present application, with a seat assembly in a forward unfolding state.

FIG. 19 is another schematic view of the stroller shown in FIG. 18, with the seat assembly in a backward unfolding state.

FIG. 20 is another schematic view of the stroller shown in FIG. 18, with the seat assembly in a folded state.

FIG. 21 is an exploded view of the child stroller shown in FIG. 18.

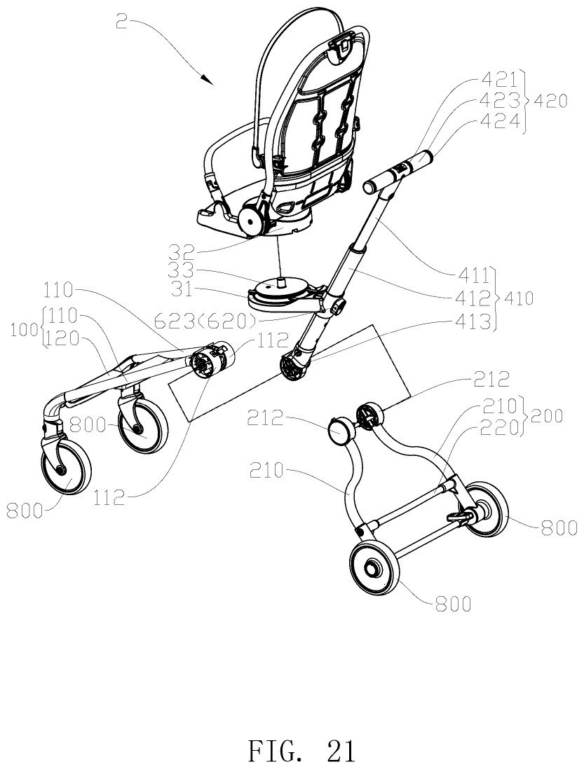

FIG. 22 is another exploded view of the stroller shown in FIG. 18.

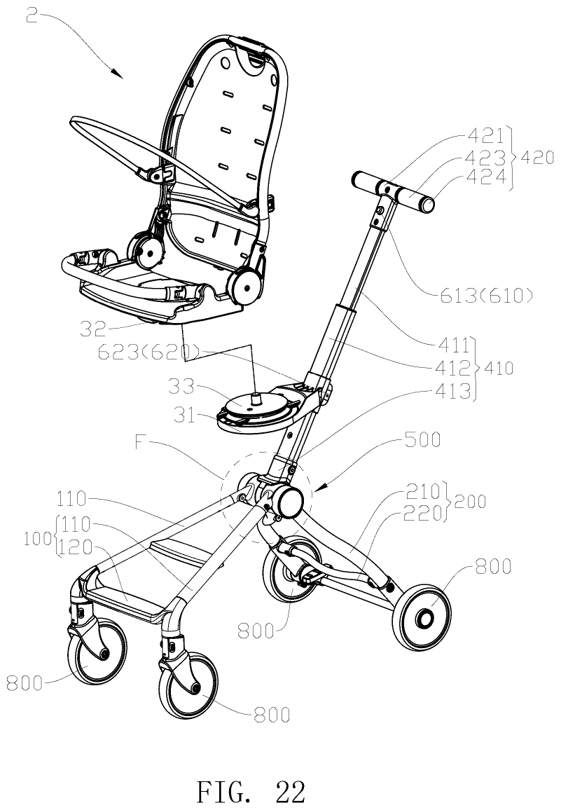

FIG. 23 is an enlarged view of portion F of FIG. 22.

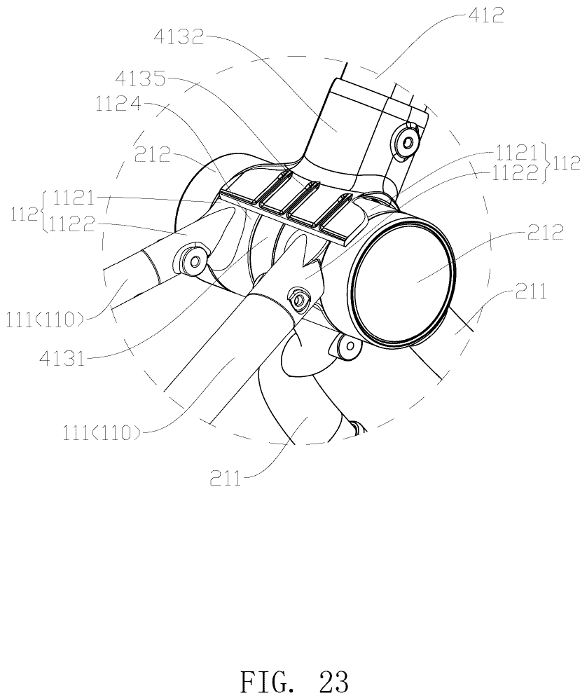

FIG. 24 is a schematic view of a portion of a frame shown in FIG. 22 from another perspective.

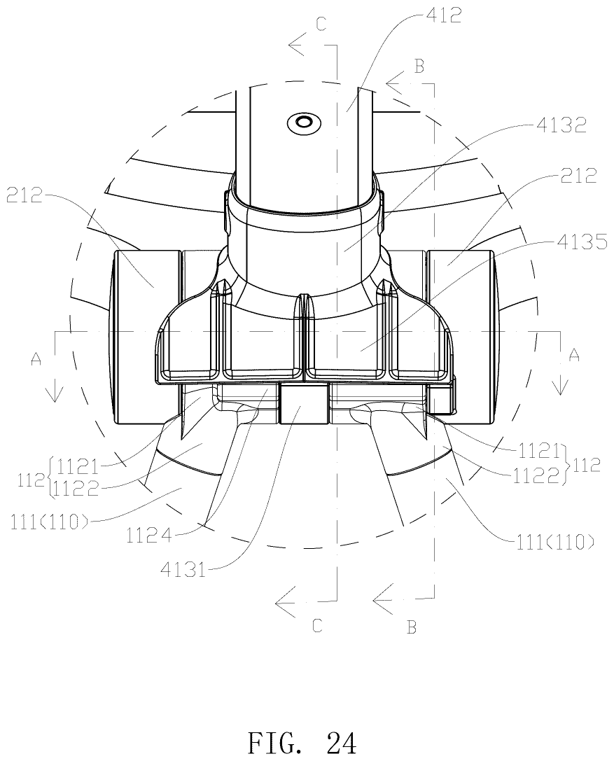

FIG. 25 is an exploded view of a linkage assembly and a portion of the frame shown in FIG. 23.

FIG. 26 is an exploded view of the linkage assembly and a portion of the frame shown in FIG. 23 from another perspective.

FIG. 27 is a cross-sectional view taken along a line A-A of FIG. 24.

FIG. 28 is a cross-sectional view taken along a line B-B of FIG. 24.

FIG. 29 is a cross-sectional view taken along a line C-C of FIG. 24.

FIG. 30 is a schematic view of a seat frame and a movable base of the seat locking device of the stroller shown in FIG. 1, with a connecting base is in a first moving position.

FIG. 31 is another schematic view of the seat frame and the movable base of the seat locking device of the stroller shown in FIG. 1, with the connecting base in a second moving position and rotated by a certain angle.

FIG. 32 is an exploded view of the seat frame and movable base shown in FIG. 30.

FIG. 33 is a cross-sectional view of the seat frame and the movable base shown in FIG. 30, with a first locking mechanism in a locked state.

FIG. 34 are another cross-sectional view of the seat frame and the movable base shown in FIG. 30, with the first locking mechanism in an unlocked state.

FIG. 35 is a partial schematic view of the stroller shown in FIG. 1 from another perspective, with the connecting base in the second moving position and rotated by a certain angle.

FIG. 36 is an enlarged view of portion G in FIG. 35.

FIG. 37 is a cross-sectional view of the stroller in FIG. 35, with the connecting base in the first moving position.

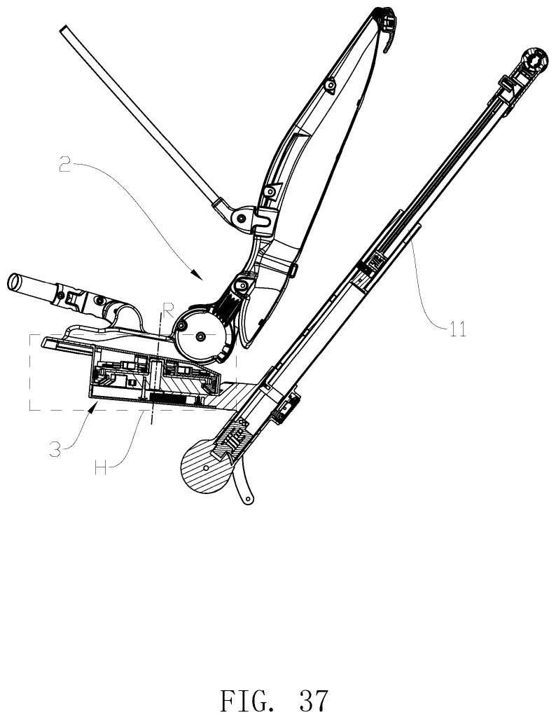

FIG. 38 is an enlarged view of portion H in FIG. 37.

FIG. 39 is an enlarged view of position I in FIG. 38.

FIG. 40 is a schematic view of the seat assembly and the connecting base of the stroller shown in FIG. 1.

FIG. 41 is a cross-sectional view of a second locking mechanism and the connecting base of the stroller shown in FIG. 40.

FIG. 42 is an exploded view of the seat assembly, the connecting base and the second locking mechanism shown in FIG. 40 from another perspective.

FIG. 43 is an exploded view of the second locking mechanism shown in FIG. 42.

### ILLUSTRATION FOR REFERENCE NUMERALS

1, frame;
100, first wheel frame; 110, first support assembly; 111, first support rod; 112, first rotating base; 1121, the first pivot part; 1122, first connecting part; 1123, second guide groove; 1124, second limiting protrusion; 1125, locking recess; 120. first connecting rod;
200. second wheel frame; 210. second support assembly; 211, second support rod; 212, second rotating base; 2121, third limiting protrusion; 2122, mounting post; 2123, mounting groove; 220, second connecting rod;
2, seat assembly;
3, seat locking device;
31, seat frame; 311, support part; 312, guide rail; 3121, rotating notch; 3122, switching notch; 3123, first section; 3125, second section; 3124, third section; 3126, outer end; 3127, chamfer or rounded corner; 313, third receiving groove; 314, limiting convex part; 315, mounting part; 3151, accommodating groove; 3152, through hole; 3153, mounting post;
32, connecting base, 321, first guide groove; 322, first housing; 323, third groove; 324, second housing; 325, receiving chamber; 3251, sidewall of the receiving chamber; 3252, second groove; 326, first insertion hole; 327, first opening; 328, second opening; 329, boss;
33, movable base; 331, engaging groove 332, second guide groove 333, connecting shaft; 334, accommodating cavity; 335, disc-shaped part; 336, truncated cone part; 337, through opening;
34, first locking mechanism; 341, reversing unlocking member; 3411, first recess; 3412, positioning groove; 3413, reversing operating part; 3414, limiting member; 342, reversing reset member; 343, positioning pin;
35, second locking mechanism; 351, separation locking member; 351a; first separation locking member; 351b, second separation locking member; 3511, hook part; 3512, wedge-shaped surface; 3513, first protrusion; 3514, second protrusion; 3515, locking driving surface; 3515a, first locking driving surface; 3515b, second locking driving surface;
352, separation unlocking member; 352a, first separation unlocking member; 352b, second separation unlocking member; 3521, first driving groove; 3522a/3522b, second driving groove; 3523, unlocking driving surface; 3523a, first unlocking driving surface; 3523b, second unlocking driving surface; 3524, second insertion hole; 3525, separation driving member; 3526, separation operating part; 3527, operation hole; 353, separation reset member;
36, movable post; 37, moving reset member;
400. push rod frame; 410. push rod assembly; 411, first push rod; 411a, accommodation cavity; 412, second push rod; 413, pivot base; 4131, second pivot part; 4132, second connecting part; 4133, first receiving cavity; 4135, first limiting protrusion; 414, guide base; 414a, first groove; 420, handle assembly; 421, connecting sleeve; 4211, first sleeve part; 4212, second sleeve parr; 4212a, insertion opening; 4212b, abutting boss; 4212c, operating hole; 4212d, first mounting recess; 422, handle body; 423, handle part; 4231, connecting protrusion; 424, cover;
500. folding mechanism; 510. rotating shaft; 520. unlocking assembly; 521, locking member; 5211, reset cavity; 5212, abutting wall; 5213, first coupling post; 522, driving member; 5221, connecting groove; 5222, second mounting recess; 523, pulling member; 524, first reset member; 525, safety unlocking member; 5251, moving part; 5252, operating part; 526, limiting member; 5261, second coupling post; 527, second reset member; 530, linkage assembly; 531, first linking rod; 532, second linking rod; 533, third linking rod; 534, driving shaft. 535, sun gear; 536, rotary plate; 5361, first guide groove; 5362, toothed edge; 5363, first end; 5364, second end; 537, planetary gear;
610, length adjustment mechanism; 611, second locking hole; 612, second locking pin; 613, length adjustment operating member; 614, linking member; 615, fourth reset member; 617b, second drive pin; 620, seat height adjustment mechanism; 621, first locking hole; 622, first locking pin; 623, height adjustment operating member; 6231, operating end; 6232, pivot end; 6233, abutting groove; 624, third reset member;
710, fastener; 720, pivoting member;
R, rotation axis; D1, first direction; D2, second direction; DM1, first moving direction; DM2, second moving direction.

### DETAILED DESCRIPTION

In order to make the objects, features and advantages of the present application more clear and easy to understand, the specific implementations of the present application will be described in detail below with reference to the accompanying drawings. It should be understood that the specific implementations described herein are only used to illustrate the present application and do not limit the protection scope of the present application.

It should be noted that when an element is referred to as being “fixed to” another element, it can be directly on the other element or an intermediate element may also be present. When an element is referred to as being “connected” to another element, it can be directly connected to the other element or there may also be an intermediate element. The term “vertical”, “horizontal”, “upper”, “lower”, “left”, “right” or similar expressions used herein, is for illustrative purposes only and do not represent the unique implementations.

Unless otherwise defined, all technical and scientific terms used herein have the same meaning as commonly understood by one of ordinary skill in the technical field to which this application belongs. The terms used herein in the description of the present application are for the purpose of describing specific implementations only and is not intended to limit the present application. As used herein, the term “and/or” includes any and all combinations of one or more of the associated listed items.

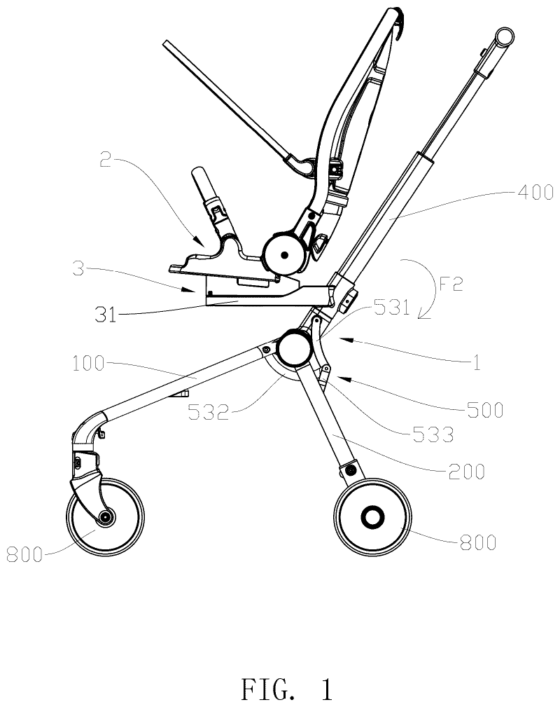

As shown in FIGS. 1 to 3, an embodiment of the present application provides a child carrier, which is more convenient to fold. Specifically, the child carrier includes a frame 1, a seat locking device 3, and a seat assembly 2. The frame 1 includes a first wheel frame 100, a second wheel frame 200, a push rod frame 400, and a folding mechanism 500. The first wheel frame 100, the second wheel frame 200, and the push rod frame 400 are pivotally connected to each other, so that the first wheel frame 100 and the second wheel frame 200 are arranged at an included angle to form a stable triangular support structure with respect to the ground. The push rod frame 400 is located above the first wheel frame 100 and the second wheel frame 200 to facilitate pushing. The folding mechanism 500 is disposed among the first wheel frame 100, the second wheel frame 200 and the push rod frame 400, and is configured to realize the rotation and folding of the first wheel frame 100, the second wheel frame 200 and the push rod frame 400.

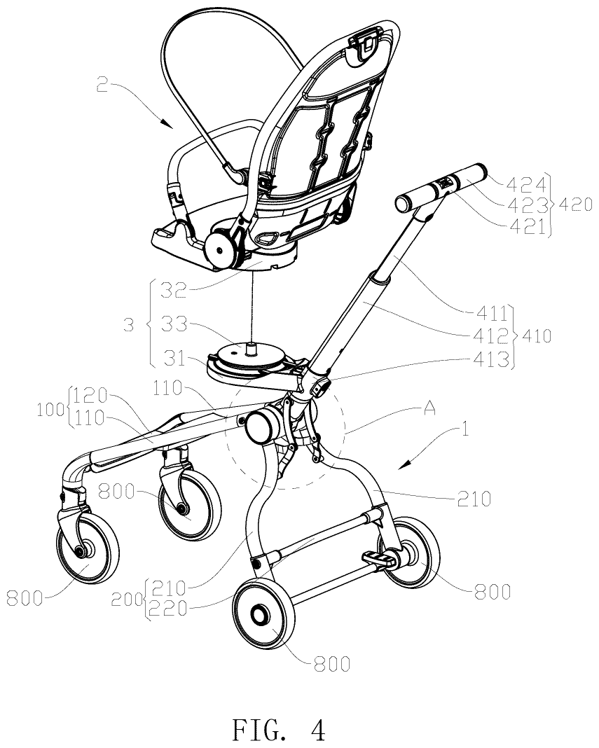

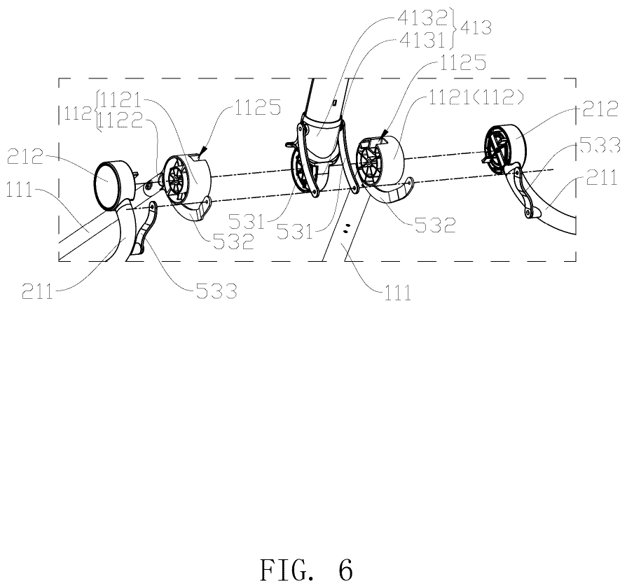

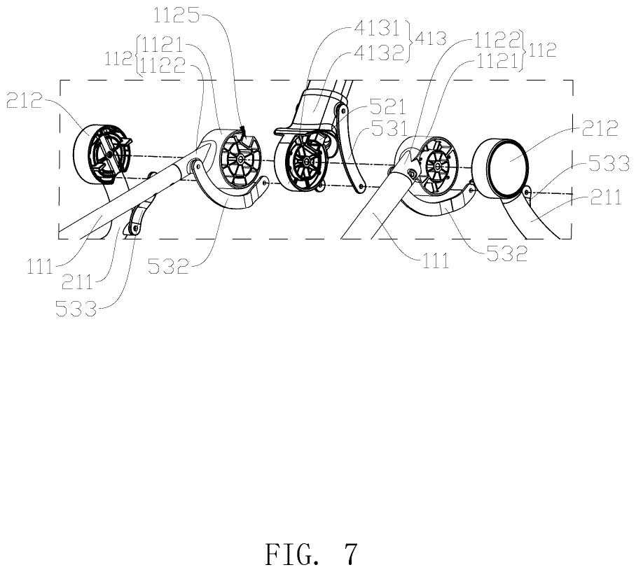

Specifically, as shown in FIG. 4, the first wheel frame 100 includes two first support assemblies 110 spaced apart in a left-right direction of the frame 1. First ends of the two first support assemblies 110 relatively move towards each other and are pivotally connected to the push rod frame 400, and second ends of the two first support assemblies 110 are relatively away from each other and connected to the two wheel assemblies 800 respectively. At least one first connecting rod 120 is further connected between the two first support assemblies 110. Referring to FIGS. 6 and 7, each first support assembly 110 includes a first support rod 111 and a first rotating base 112 connected to the first support rod 111. In this embodiment, the first rotating base 112 includes a substantially disk-shaped first pivot part 1121 and a first connecting part 1122 fixedly connected to the first pivot part 1121. In this embodiment, the first connecting part 1122 is shaped as a sleeve to be sleeved on the first end of the first support rod 111 away from the wheel assembly 800. In other embodiments, the first connecting part 1122 can also be connected to the first support rod 111 by soldering, welding, riveting or the like. Alternatively, the first connecting part 1122 (or a second rotating base 212 as described later) and the first support rod 111 can be integrally formed.

Specifically, as shown in FIGS. 4 to 6, the second wheel frame 200 has a similar configuration to the first wheel frame 100, and the second wheel frame 200 also includes two second support assemblies 210 spaced apart in the left-right direction of the frame 1. First ends of the two second support assemblies 210 relatively move towards each other and are pivotally connected to the push rod frame 400, and second ends of the two second support assemblies 210 are relatively away from each other and connected to the two wheel assemblies 800 respectively. At least one second connecting rod 220 is also connected between the two second support assemblies 210. In this way, the first wheel frame 100 and the second wheel frame 200 also each form a stable triangular support structure, thereby further improving the overall stability of the frame 1. Each second support assembly 210 includes a second support rod 211 and a second rotating base 212 connected to the second support rod 211. The second rotating base 212 is generally disk-shaped. The second rotating base 212 is connected to an end of the second support rod 211 away from the wheel assembly 800. In this embodiment, the middle portion of the second rotating base 212 is shaped as a sleeve to be sleeved on the first end of the second support rod 211 away from the wheel assembly 800. In other embodiments, the second rotating base 212 can also be connected to the second supporting rod 211 by soldering, welding, riveting or the like. Alternatively, the second rotating base 212 and the second supporting rod 211 can be an integrally formed.

Specifically, as shown in FIG. 4, the push rod frame 400 includes a push rod assembly 410 and a handle assembly 420. The push rod assembly 410 and the handle assembly 420 are connected to each other and arranged in a substantially T shape. An end of the push rod assembly 410 away from the handle assembly 420 is pivotally connected to the first wheel frame 100 and the second wheel frame 200. The handle assembly 420 is configured to be hold by a user, to facilitate the user to push the child carrier to move.

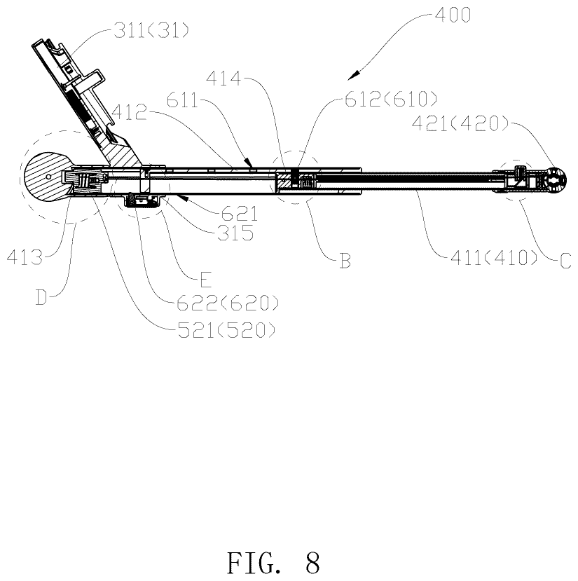

Further, as shown in FIG. 8, the push rod assembly 410 includes a first push rod 411, a second push rod 412, and a pivot base 413. The first push rod 411 and the second push rod 412 are slidingly connected to each other. In this embodiment, the first push rod 411 is at least partially inserted into the second push rod 412. The length of the push rod assembly 410 can be adjusted through a length adjustment mechanism 610. The length adjustment mechanism 610 has a locked state and an unlocked state. When the length adjustment mechanism 610 is in the unlocked state, the first push rod 411 can move in an extending direction of the second push rod 412 to extend or shorten the push rod assembly. When the length adjustment mechanism 610 is in the locked state, the first push rod 411 and the second push rod 412 are fixed relative to each other.

Specifically, the length adjustment mechanism 610 can be in various forms. For example, as shown in FIGS. 8 to 10, the length adjustment mechanism 610 may include: a plurality of second locking holes 611 disposed one of the first push rod 411 and the second push rod 412; a second locking pin 612 disposed the other of the first push rod 411 and the second push rod 412; a length adjustment operating member 613; a linking member 614; and a fourth reset member 615.

In this embodiment, as shown in FIGS. 8 to 10, the plurality of second locking holes 611 are disposed in the second push rod 412. The second locking pin 612 is movably disposed at a portion of the first push rod 411 away from the handle assembly 420. The second locking pin 612 is moveable between a fifth position and a sixth position. When the second locking pin 612 is in the fifth position, the second locking pin 612 can be inserted into one of the second locking holes 611. When the second locking pin 612 is in the sixth position, the second locking pin 612 can be separated from the second locking hole 611. The length adjustment operating member 613 is disposed on the first push rod 411 and is connected to the second locking pin 612 through the linking member 614. The length adjustment operating member 613 is operable to drive the second locking pin 612 to switch between the fifth position and the sixth position.

Specifically, as shown in FIGS. 8 to 10, one of the linking member 614 and the length adjustment operating member 613 may be provided with a first driving groove (not shown), and the other of the linking member 614 and the length adjustment operating member 613 is provided with a first drive pin (not shown). An extending direction of the first driving groove intersects with, but is not perpendicular to the moving direction of the length adjustment operating member 613. The first drive pin is inserted into the first driving groove and can move along the first driving groove. One of the linking member 614 and the second locking pin 612 is provided with a second driving groove (not shown), and the other of the linking member 614 and the second locking pin 612 is provided with a second drive pin 617b. An extending direction of the second driving groove intersects with, but is not perpendicular to the moving direction of the length adjustment operating member 613. The second drive pin 617b is inserted into the second driving groove and can move along the second driving groove. The first driving groove and the second driving groove are spaced apart.

Further, as shown in FIGS. 8 to 10, the first push rod 411 may be provided with an accommodation cavity 411a extending parallel to an extending direction of the first push rod 411. The push rod assembly 410 further includes a guide base 414. The guide base 414 is disposed in the accommodation cavity 411a. The guide base 414 is provided with a first groove 414a, a second groove (not shown), and a strip hole (not shown) extending through the first groove 414a and the second groove. The extending direction of the second groove intersects with the extending directions of the first groove 414a and the strip hole. The second locking pin 612 is movably inserted into the first groove 414a. The second drive pin 617b extends through the strip hole, to connect the second locking pin 612 to the linking member 614. Both ends of the fourth reset member 615 respectively abut against the linking member 614 and the guide base 414. The fourth reset member 615 biases the linking member 614 to move in the direction of driving the second locking pin 612 to move to the fifth position.

The length adjustment process of the push rod assembly 410 in this embodiment is described in detail below.

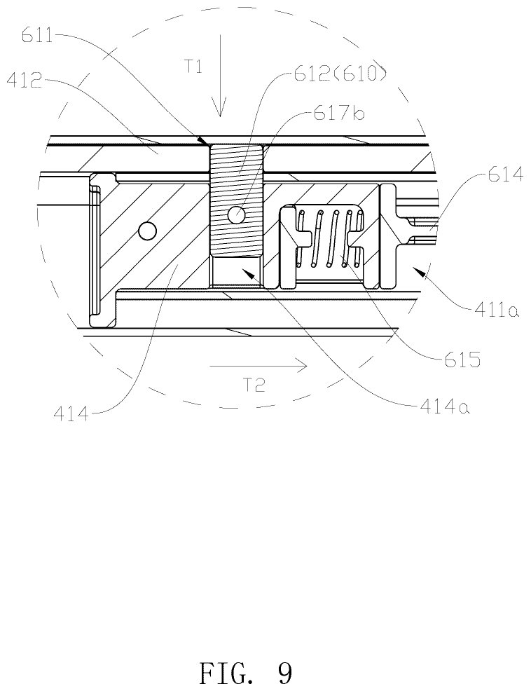

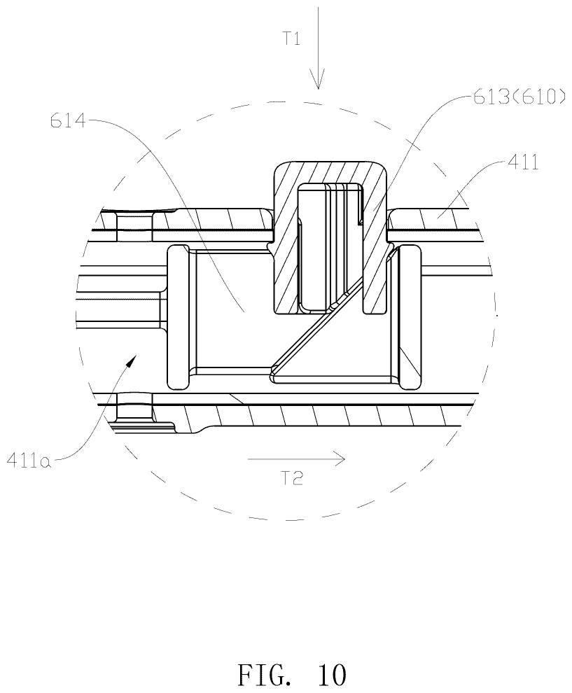

When it is necessary to adjust the length of the push rod assembly 410, as shown in FIG. 10, the length adjustment operating member 613 is pressed in a direction T1, and at the same time, the length adjustment operating member 613 drives the linking member 614 to move in a direction T2 through the cooperation between the first driving groove and the first drive pin, so that the fourth reset member 615 is compressed. As shown in FIG. 9, the linking member 614 then drives the second locking pin 612 to move in the direction T1 through the cooperation between the second driving groove and the second drive pin 617b. When the second locking pin 612 moves to be separated from the respective one of the second locking holes 611, the length adjustment mechanism 610 is unlocked. Then, the first push rod 411 can move relative to the second push rod 412. In this case, the overall length of the push rod assembly 410 can be adjusted by moving the first push rod 411 relative to the second push rod 412.

When the first push rod 411 moves to face another of the second locking holes 611 as needed, the pressing force on the length adjustment operating member 613 can be removed, and the linking member 614 moves in an opposite direction of the direction T2 under the elastic force of the fourth reset member 615. At the same time, the linking member 614 moves the second locking pin 612 in the opposite direction of the direction T1 to be re-inserted into the another of the second locking holes 611 through cooperation between the second driving groove and the second drive pin 617b, so that the first push rod 411 and the second push rod 412 are re-locked. At the same time, the linking member 614 also drives the length adjustment operating member 613 to move and reset in the opposite direction of the direction T1 through the cooperation between the first driving groove and the first drive pin.

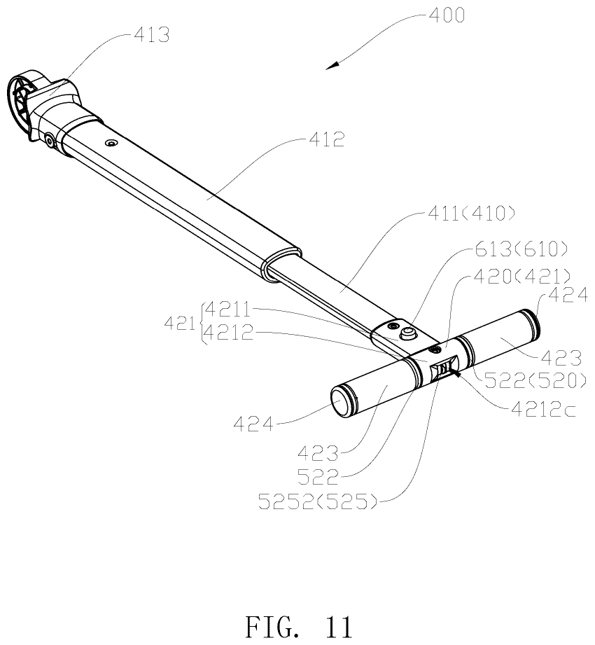

Specifically, as shown in FIGS. 11 to 13, the handle assembly 420 includes a connecting sleeve 421, a handle body 422, a handle part 423, and a cover 424. The connecting sleeve 421 is generally T-shaped, and includes a first sleeve part 4211 and a second sleeve part 4212 that are in communication with each other. The first sleeve part 4211 is sleeved on an end of the first push rod 411 of the push rod assembly 410. The handle body 422 is a hollow rod. The second sleeve part 4212 is sleeved on substantially the middle portion of the handle body 422. The second sleeve part 4212 and the handle body 422 are fixedly connected through a fastener 710. Two handle parts 423 are provided. The two handle parts 423 are spaced apart on the handle body 422. The two handle parts 423 are rotatable relative to the handle body 422. In this embodiment, the two handle parts 423 are respectively located on two sides of the second sleeve part 4212. Two covers 424 are respectively covered and fixed on both ends of the handle body 422, and are respectively located on the sides of the two handle parts 423 away from the second sleeve part 4212.

Further, as shown in FIGS. 6 and 7, the pivot base 413 includes a substantially disc-shaped second pivot part 4131 and a second connecting part 4132 fixedly connected to the second pivot part 4131. The second connecting part 4132 of the pivot base 413 is connected to the second push rod 412 of the push rod assembly 410. In this embodiment, the second connecting part 4132 is shaped as a sleeve to be sleeved on an end of the second push rod 412 away from the handle assembly 420. In other embodiments, the second connecting part 4132 can also be connected to the second push rod 412 by soldering, welding, riveting or the like. Alternatively, the second connecting part 4132 or the pivot base 413 and the second push rod 412 can be integrally formed.

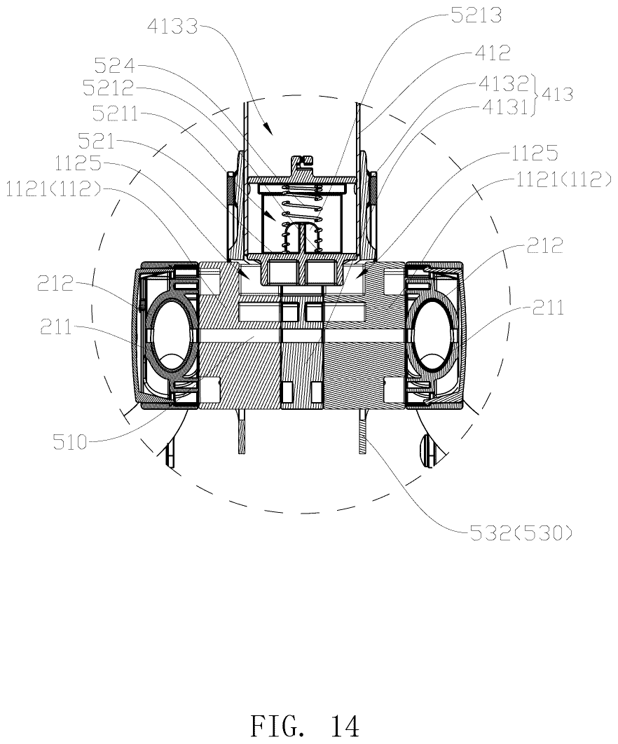

Further, as shown in FIGS. 6 and 14, the first pivot parts 1121 of the two first rotating bases 112, the two second rotating bases 212, and the second pivot part 4131 of the pivot base 413 are pivotally connected through a rotating shaft 510. Specifically, the two first rotating bases 112 are disposed on the left and right sides of the pivot base 413, and the two second rotating bases 212 are respectively disposed on the sides of the two first rotating bases 112 away from the pivot base 413. In this embodiment, the two first rotating bases 112 are respectively fastened at both sides of the pivot base 413, and respectively abut against two side surfaces of the pivot base 413. The two second rotating bases 212 are respectively fastened at the sides of the two first rotating bases 112 away from the pivot base 413, and respectively abut against the side surfaces of the two first rotating bases 112 away from the pivot base 413, so that the shaking of the frame 1 can be reduced during the rotations of the first rotating base 112, the second rotating base 212 and the pivot base 413.

Specifically, as shown in FIGS. 14 to 16, the folding mechanism 500 includes a rotating shaft 510, an unlocking assembly 520, and a linkage assembly 530.

Specifically, as shown in FIGS. 14 to 16, the unlocking assembly 520 includes a locking member 521, a driving member 522, a pulling member 523, and a first reset member 524. The locking member 521 has a generally columnar structure. In this embodiment, a first receiving cavity 4133 is disposed in the second connecting part 4132 of the pivot base 413. The locking member 521 is movably disposed in the first receiving cavity 4133. The two second rotating bases 212 are each provided with locking recesses 1125 that can be in communication with the first receiving cavity 4133. As shown in FIGS. 6 and 7, the locking recesses 1125 of the two second rotating bases 212 are both disposed on the respective outer peripheries of the two second rotating bases 212. Openings of the locking recesses 1125 face the first receiving cavity 4133 of the second connecting part 4132. The unlocking assembly 520 has a locked state and an unlocked state. When the unlocking assembly 520 is in the locked state, the locking member 521 is located at a relatively low position in the first receiving cavity 4133 and is inserted into both the two locking recesses 1125, so that the pivot base 413 and the two first rotating bases 112 are fixed relative to each other. When the unlocking assembly 520 is in the unlocked state, the locking member 521 is located at a relatively high position in the first receiving cavity 4133 to be separated from the two locking recesses 1125 so that the pivot base 413 is rotatable relative to the two first rotation bases 112.

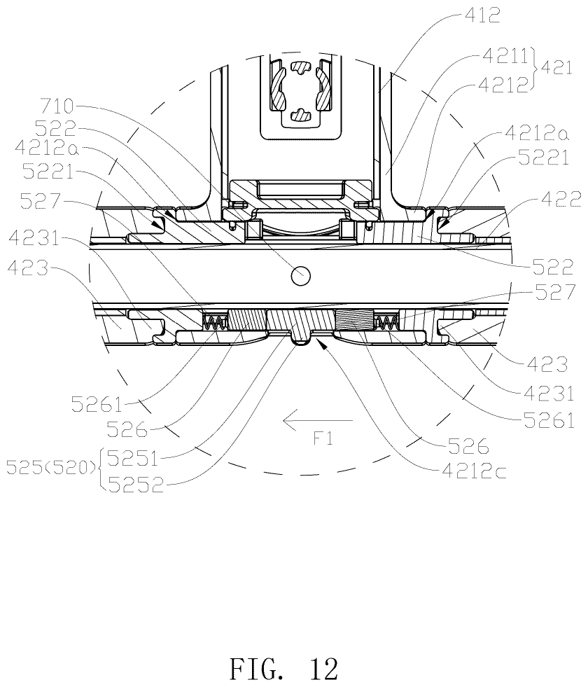

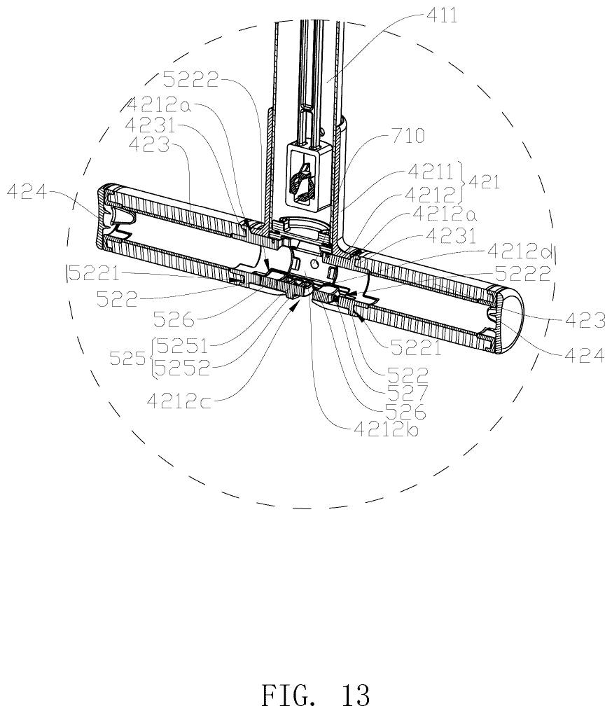

Further, as shown in FIGS. 12 and 13, two driving members 522 are provided. The two driving members 522 are rotatably disposed on the handle body 422. Specifically, both ends of the second sleeve part 4212 include insertion openings 4212a respectively. The two driving members 522 are cylindrical, and are sleeved on the handle body 422 at intervals, while at least partially being inserted into the two insertion openings 4212a respectively. The two driving members 522 can rotate relative to the second sleeve part 4212. An abutting boss 4212b is disposed at substantially the middle portion of the inner wall of the second sleeve part 4212. Two sides of the abutting boss 4212b respectively abut against the two driving members 522 respectively inserted into the insertion openings 4212a. The two driving members 522 are respectively connected to the handle part 423 on the corresponding side. In this embodiment, each driving member 522 is provided with a connecting groove 5221, and each handle part 423 is provided with a connecting protrusion 4231 that can be inserted into the corresponding connecting groove 5221 at one end adjacent to the second sleeve part 4212. In other embodiments, the driving member 522 and the handle part 423 can also be connected by other means.

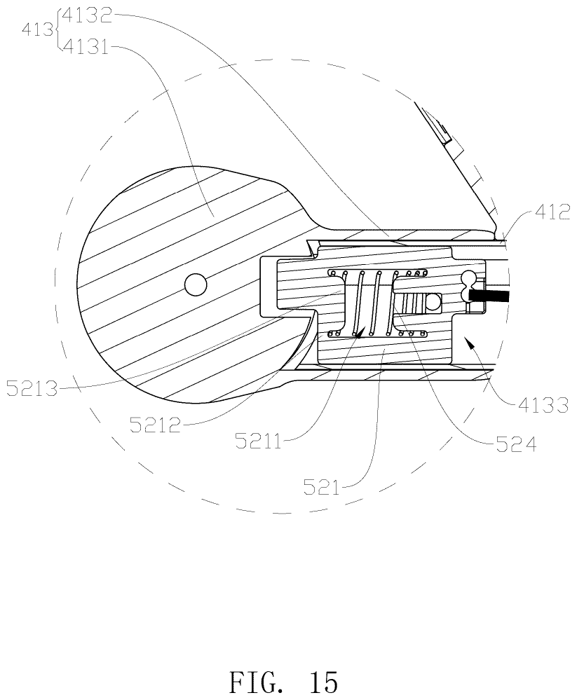

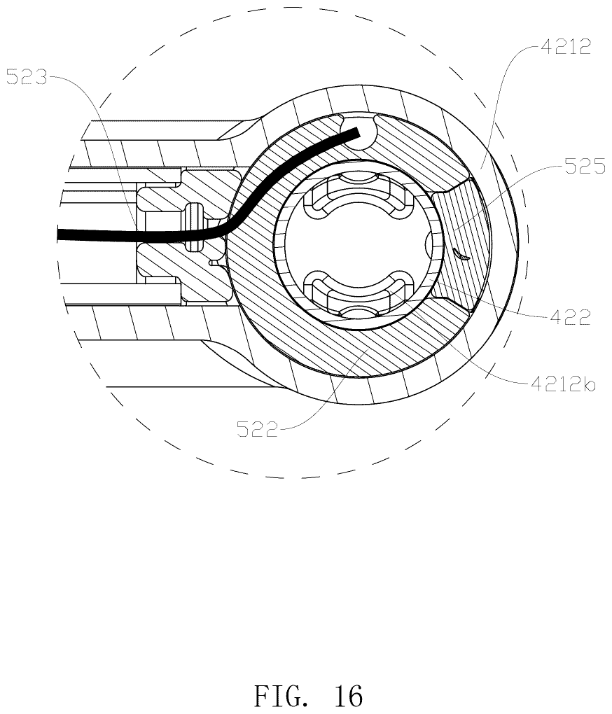

In this embodiment, as shown in FIGS. 15 and 16, the pulling member 523 is a steel wire rope. In other embodiments, the pulling member 523 can also be other linear objects with certain rigidity. Two pulling members 523 are provided. Both ends of each pulling member 523 are respectively connected to the locking member 521 and one of the driving members 522. In this way, when one of the handle parts 423 is rotated to drive the driving member 522 to rotate, the driving member 522 can drive the locking member 521 through the pulling member 523, to move in a direction away from the locking recesses 1125, thereby switching the unlocking assembly 520 from the locked state to the unlocked state.

Further, as shown in FIGS. 14 and 15, both ends of the first reset member 524 abut against the locking member 521 and the pivot base 413 respectively. The first reset member 524 is adapted to bias the locking member 521 so that the locking member 521 moves towards the direction of being inserted into the locking recesses 1125. Specifically, the pivot base 413 is provided with a pin (not shown). The pin extends through the pivot base 413 and the second push rod 412 to fix the pivot base 413 on the second push rod 412. A reset cavity 5211 is disposed inside the locking member 521. The reset cavity 5211 includes an abutting wall 5212. A first coupling post 5213 is disposed on the abutting wall 5212. The pin can extend into the reset cavity 5211. The first reset member 524 is disposed in the reset cavity 5211. The first reset member 524 is sleeved outside the first coupling post 5213. Two ends of the first reset member 524 are respectively in contact with the abutting wall 5212 and the pin. As such, the first reset member 524 can be prevented from being displaced during the biasing process. In this embodiment, the pin is located on a side of the abutting wall 5212 adjacent to the handle assembly 420, that is, the pin is located above the abutting wall 5212. In this way, when one of the handle parts 423 is rotated to drive the driving member 522 to rotate, the driving member 522 can drive the locking member 521 through the pulling member 523 to move in a direction away from the locking recesses 1125, and the first reset member 524 can be compressed and deformed. When the external rotating force applied to the handle part 423 is removed, the locking member 521 can move in a direction approaching the locking recesses 1125 under the elastic force of the first reset member 524, thereby switching the unlocking assembly 520 from the unlocked state to the locked state. In this embodiment, the first reset member 524 is a spring.

Specifically, as shown in FIGS. 12 and 13, the unlocking assembly 520 further includes a safety unlocking member 525, a limiting member 526, and a second reset member 527, to prevent accidental rotation of the handle part 423 which causes the unlocking assembly 520 to be accidentally unlocked.

Further, as shown in FIGS. 12 and 13, the safety unlocking member 525 and the limiting member 526 are movably disposed on the second sleeve part 4212. The safety unlocking member 525 is movable between a first position and a second position. When the safety unlocking member 525 is in the first position, the limiting member 526 limits the movement of the driving member 522. When the safety unlocking member 525 is in the second position, the limiting member 526 releases the restriction on the movement of the driving member 522. The safety unlocking member 525 is operable to move from the first position to the second position. Specifically, the safety unlocking member 525 includes a moving part 5251 and an operating part 5252 that are connected to each other. The moving part 5251 is disposed between an outer wall of the handle body 422 and an inner wall of the second sleeve part 4212. The second sleeve part 4212 is provided with a strip-shaped operating hole 4212c extending in the extending direction of the handle body 422. The operating part 5252 extends out of the second sleeve part 4212 via the operating hole 4212c in order to be operated, that is, the operating part 5252 is operable to move along the operating hole 4212c.

Further, as shown in FIGS. 12 and 13, two limiting members 526 are provided, and have a substantially block structure. The abutting boss 4212b is provided with a first mounting recess 4212d. Portions of the two driving members 522 adjacent to the abutting boss 4212b are each provided with a second mounting recess 5222. The two second mounting recesses 5222 face and are in communication with the first mounting recess 4212d, to form a mounting cavity for accommodating the limiting member 526. The operating hole 4212c is in communication with the mounting cavity. The two limiting members 526 are movably disposed in the mounting cavity and are respectively located on both sides of the safety unlocking member 525. Taking one of the limiting members 526 as an example, when the limiting member 526 moves until a portion of the limiting member 526 is located in the first mounting recess 4212d and another portion of the limiting member 526 is located in the second mounting recess 5222, the limiting member 526 can abut against the abutting boss 4212b, so that the driving member 522 cannot be rotated. When the entire limiting member 526 is moved into the second mounting recess 5222, the limiting member 526 does not abut against the abutting boss 4212b, so that the driving member 522 can be rotated. Two second reset members 527 are provided. The two second reset members 527 are both disposed in the mounting cavity and are respectively located on the sides of the two limiting members 526 away from the safety unlocking member 525. Two ends of each second reset member 527 respectively abut against the driving member 522 and the limiting member 526 on the corresponding side. The second reset member 527 is adapted to bias the limiting member 526 on the corresponding side so that the corresponding limiting member 526 moves towards a direction of limiting the movement of the corresponding driving member 522. One of the second reset members 527 is taken as an example to illustrate its arrangement in detail. The limiting member 526 is provided with a second coupling post 5261 on the side away from the safety unlocking member 525. The second reset member 527 is sleeved outside the second coupling post 5261. Two ends of the second reset member 527 respectively abuts against the limiting member 526 and the bottom wall of the second mounting recess 5222. In this way, the second reset member 527 can be prevented from being displaced during the biasing process. In this embodiment, the second reset member 527 is a spring.

The working principle of preventing accidental unlocking of the safety unlocking assembly 525 is described in detail below by taking the structure on one side of the safety unlocking assembly 525 as an example.

When the safety unlocking member 525 is in the first position, as shown in FIG. 12, the limiting member 526 is partially located in the first mounting recess 4212d and partially located in the second mounting recess 5222 under the elastic force of the second reset member 527. In this way, when the handle part 423 is rotated, the driving member 522 cannot be rotated because the limiting member 526 abuts against the abutting boss 4212b, so that the locking member 521 cannot be separated from the locking recesses 1125 by the pulling member 523 to realize an unlocking of the unlocking assembly 520. In this way, the handle part 423 can be prevented from being accidentally rotated to cause the unlocking assembly 520 to be accidentally released. When it is necessary to fold the frame 1, as shown in FIG. 12, the operating part 5252 of the safety unlocking member 525 can be pushed in a direction F1 or in an opposite direction of the direction F1, so that the moving part 5251 of the safety unlocking member 525 pushes against one of the limiting members 526 until the limiting member 526 is completely located in the corresponding second mounting recess 5222, and the second reset member 527 is compressed. In this case, since the limiting member 526 does not abut against the abutting boss 4212b, rotating the handle part 423 can drive the driving member 522 to rotate, so that the locking member 521 is separated from the locking recesses 1125 by the pulling member 523 to enable the unlocking of the unlocking assembly 520.

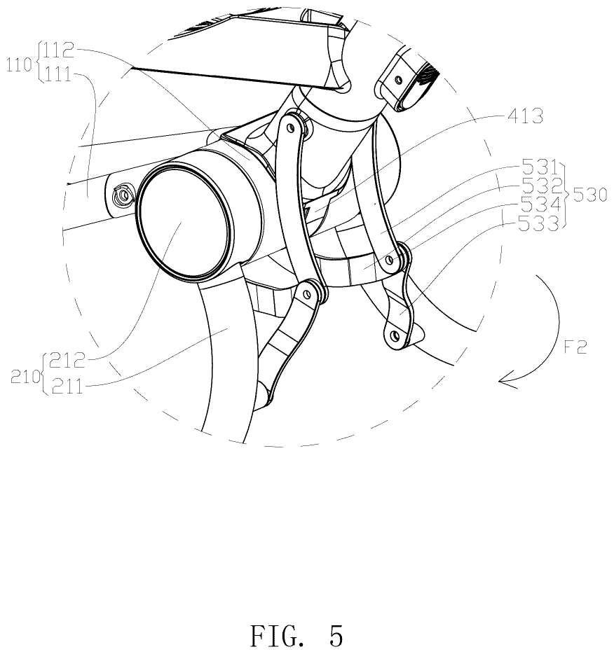

Further, as shown in FIG. 5, the folding mechanism 500 includes two linkage assemblies 530. Each first support assembly 110 and each second support assembly 210 are movably connected to the push rod assembly 410 by the respective linkage assembly 530. Each first support assembly 110 and each second support assembly 210 can be rotated and folded relative to the push rod assembly 410 by the respective linkage assembly 530.

The configuration of the linkage assembly 530 is described in detail below by taking one of the linkage assemblies 530 as an example.

The linkage assembly 530 may have various forms. For example, in a first embodiment, as shown in FIGS. 5 to 7, the linkage assembly 530 may include a first linking rod 531, a second linking rod 532, and a third linking rod 533. A first end of the first linking rod 531 is pivotally connected to a side of the pivot base 413. A first end of the second linking rod 532 is pivotally connected to a second end of the first linking rod 531, and a second end of the second linking rod 532 is pivotally connected to the first connecting part 1122 of the first rotating base 112 on the same side. A first end of the third linking rod 533 is pivotally connected to the second end of the first linking rod 531, and a second end of the third linking rod 533 is pivotally connected to the second support rod 211 on the same side. In other embodiments, the first end of the first linking rod 531 may also be pivotally connected to the second push rod 412. Alternatively, the second end of the second linking rod 532 may also be pivotally connected to the first support rod 111 on the same side. Alternatively, the second end of the third linking rod 533 may also be pivotally connected to the second rotating base 212 on the same side. In this embodiment, the second end of the first linking rod 531, the first end of the second linking rod 532 and the first end of the third linking rod 533 are pivotally connected to a driving shaft 534. The driving shaft 534 is located behind the pivot base 413 to avoid interference with the seat assembly 2 during the folding process, and also allows the frame 1 to be folded only when the push rod frame 400 is rotated in a direction F2, which can provide a certain limiting protection.

The working principle of the linkage assembly 530 in this embodiment is described in detail below.

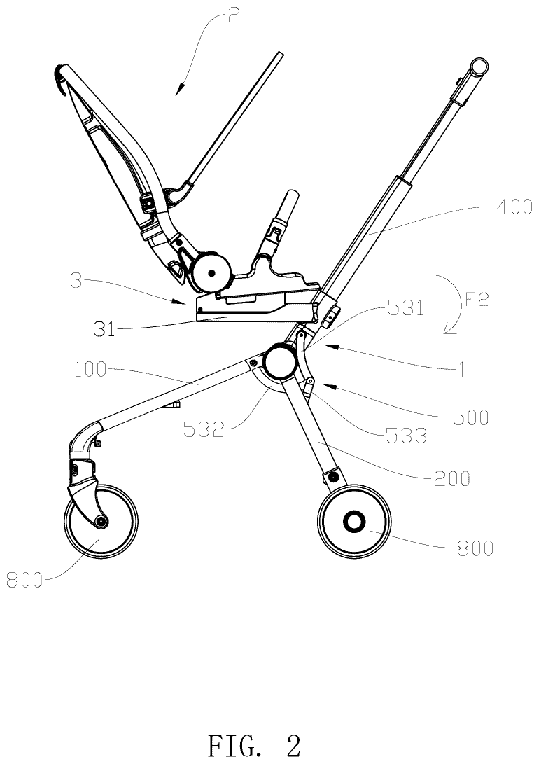

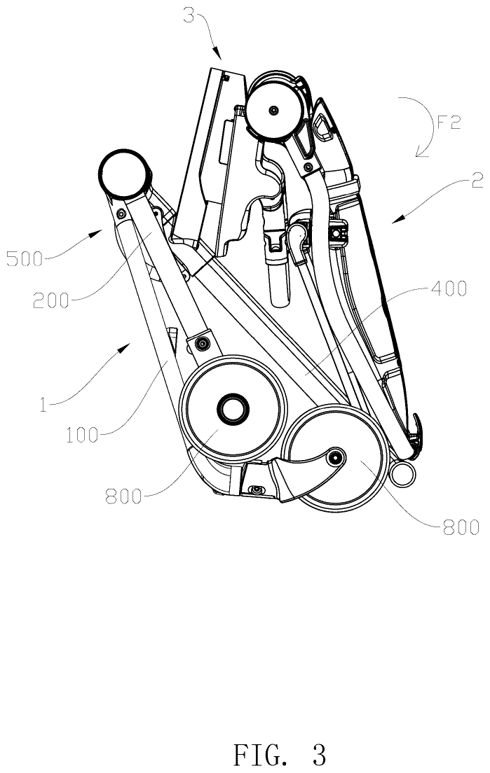

When it is necessary to fold the frame 1, as shown in FIGS. 1 and 2, firstly, an operation is performed to realize the unlocking of the unlocking assembly 520, and then the push rod frame 400 can be rotated in the direction F2, that is, the push rod frame 400 can be moved towards the second wheel frame 200. In this case, during the rotation of the push rod frame 400, the push rod frame 400 drives the first wheel frame 100 to rotate in the opposite direction of the direction F2 by the first linking rod 531 and the second linking rod 532 that are pivoted to each other, and drives the second wheel frame 200 to rotate in the opposite direction of the direction F2 by the first linking rod 531 and the third linking rod 533 that are pivoted to each other. That is, the first wheel frame 100 and the second wheel frame 200 move towards the push rod frame 400. In this way, the push rod frame 400, the first wheel frame 100 and the second wheel frame 200 all rotate, and move towards each other to realize the overall folding of the frame 1, as shown in FIG. 3.

When it is necessary to unfold the frame 1, as shown in FIG. 3, the push rod frame 400 is rotated in the opposite direction of the direction F2, so that the push rod frame 400 rotates in a direction away from the first wheel frame 100 and the second wheel frame 200, and at the same time, the push rod frame 400 drives the first wheel frame 100 to rotate in the direction F2 by the first linking rod 531 and the second linking rod 532 that are pivoted to each other, and drives the second wheel frame 200 to rotate in the direction F2 by the first linking rod 531 and the third linking rod 533 that are pivoted to each other. That is, the first wheel frame 100 and the second wheel frame 200 are rotated and unfolded in a direction away from the push rod frame 400. When the push rod frame 400, the first wheel frame 100, and the second wheel frame 200 are rotated into position, the locking member 521 is inserted into the locking recesses 1125 under the elastic force of the first reset member 524, thereby locking the frame 1 in an unfolded state, as shown in FIGS. 1 and 2.

In this embodiment, two linkage assemblies 530 formed by the first linking rod 531, the second linking rod 532, and the third linking rod 533 are respectively disposed on two sides of the pivot base 413, so that the push rod frame 400 can synchronously and smoothly drive the first wheel frame 100 and the second wheel frame 200 to rotate and be folded during its rotation. In other embodiments, the folding mechanism 500 may also include only one linkage assembly 530. The first linking rod 531, the second linking rod 532, and the third linking rod 533 of the linkage assembly 530 are all located on the same side of the pivot base 413. That is, the push rod frame 400 can drive both the first wheel frame 100 and the second wheel frame 200 to rotate and fold through only one linkage assembly 530.

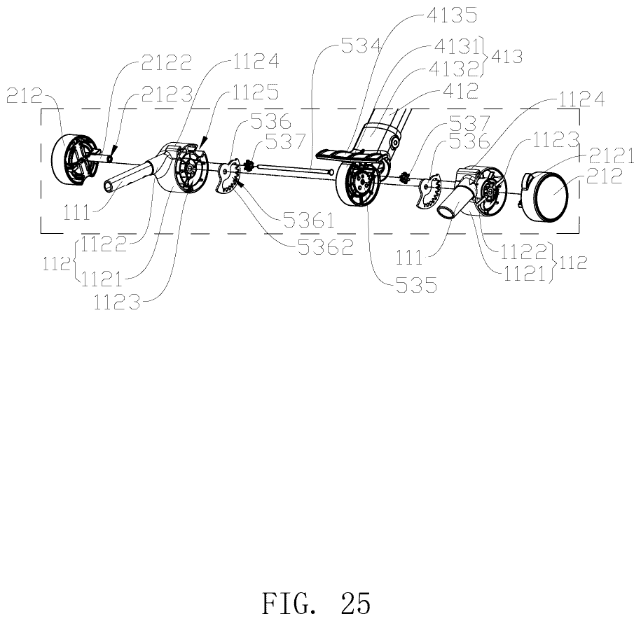

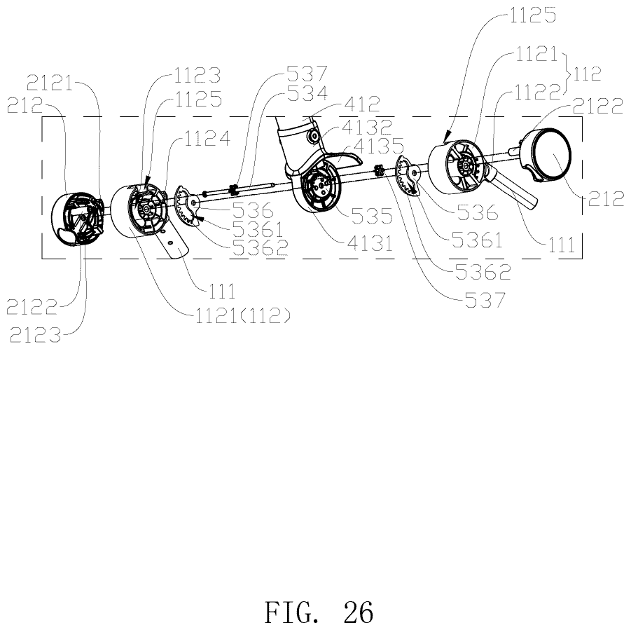

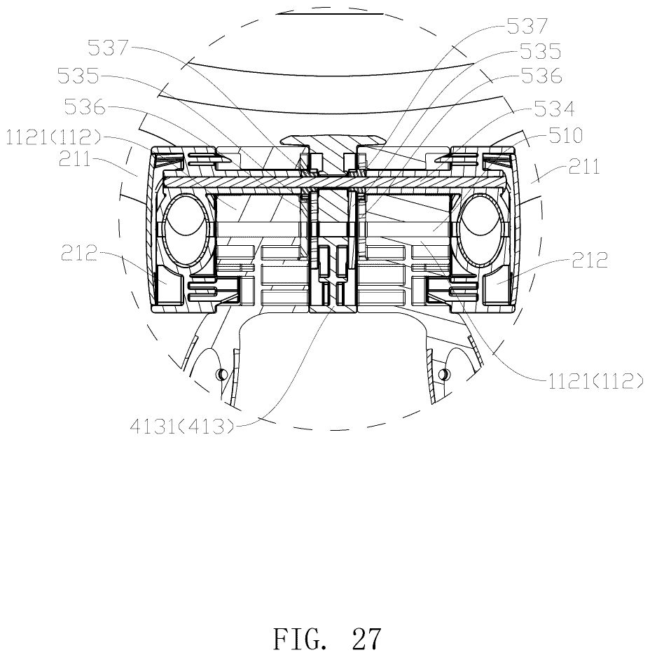

In a second embodiment, as shown in FIGS. 25 and 26, the linkage assembly 530 may also include a sun gear 535, a rotary plate 536, planetary gears 537, and a driving shaft 534. The sun gear 535 is fixed to a side of the second pivot part 4131 of the pivot base 413. The rotary plate 536 is fixed to a side of one of the first rotating bases 112 facing the pivot base 413. The planetary gears 537 are respectively disposed between the corresponding first rotating base 112 and the pivot base 413. As shown in FIG. 27, the driving shaft 534 is eccentrically arranged with respect to the rotating shaft 510. The driving shaft 534 extends through the second rotating base 212, the planetary gear 537, and the pivot base 413. The second rotating base 212 is pivotally connected to the pivot base 413 by the driving shaft 534.

The specific configuration of one of the linkage assemblies 530 in this embodiment is described in detail below.

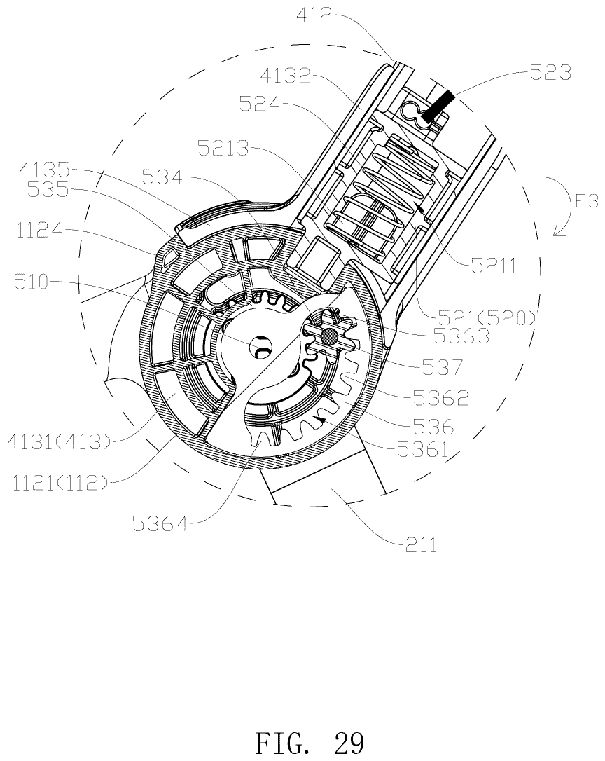

Specifically, as shown in FIGS. 25 and 26, at least a portion of the outer periphery of the sun gear 535 is provided with a plurality of gear teeth in a circumferential direction. In this embodiment, the plurality of gear teeth are disposed on the periphery of the sun gear 535, accounting for one third of the circumference. In other embodiments, the area where the gear teeth are disposed on the periphery of the sun gear 535 can also be adjusted as needed. The sun gear 535 is fixed to the side of the second pivot part 4131 of the pivot base 413 and is coaxially arranged with the second pivot part 4131. The rotating shaft 510 extends through the center of circle of the sun gear 535. The rotary plate 536 is generally in a one-third fan-shaped sheet structure, and the rotary plate 536 is provided with an arc-shaped first guide groove 5361. As shown in FIG. 29, the groove wall of the first guide groove 5361 includes a toothed edge 5362. The toothed edge 5362 is generally parallel to the arc edge of the rotary plate 536. The tooth tip of the toothed edge 5362 faces the center of circle of the rotary plate 536. In other words, the toothed edge 5362 is arranged along a circumferential direction of the rotary plate 536. The toothed edge 5362 is disposed on the groove wall of the first guide groove 5361 away from the center of circle of the rotary plate 536. A plurality of gear teeth are provided on the entire periphery of the planetary gear 537. The planetary gear 537 is engaged with the sun gear 535 and the toothed edge 5362 of the rotary plate 536. The toothed edge 5362 includes a first end 5363 and a second end 5364, for limiting movement of the planet gear 537 between the first end 5363 and the second end 5364.

Specifically, as shown in FIGS. 25 and 26, a surface of the second rotating base 212 facing the first rotating base 112 is provided with a mounting post 2122. The mounting post 2122 is provided with a mounting groove 2123 extending in its length direction. The first rotating base 112 is provided with a second guide groove 1123 extending therethrough. The mounting post 2122 can extend through the second guide groove 1123 and move along the second guide groove 1123. A first end of the driving shaft 534 is inserted and fixed in the mounting groove 2123, and a second end of the driving shaft 534 extends through the planetary gear 537 and the pivot base 413 in sequence. The planetary gear 537 is fixedly connected to the driving shaft 534, and the driving shaft 534 is rotatable relative to the pivot base 413.

In this embodiment, the two linkage assemblies 530 essentially have the same driving shaft 534. Therefore, the first end of the driving shaft 534 is inserted and fixed in the mounting groove 2123 of one of the second rotating bases 212, and the second end of the driving shaft 534 extends through one of the planetary gears 537, the pivot base 413, and the other planetary gears 537 in sequence, and is inserted and fixed in the mounting groove 2123 of the other of the second rotating bases 212. The two planetary gears 537 are both fixedly connected to the driving shaft 534. The driving shaft 534 can rotate relative to the pivot base 413. In other embodiments, the two linkage assemblies 530 may also have different driving shafts 534.

The working principle of the linkage assembly 530 in this embodiment are described in detail below.

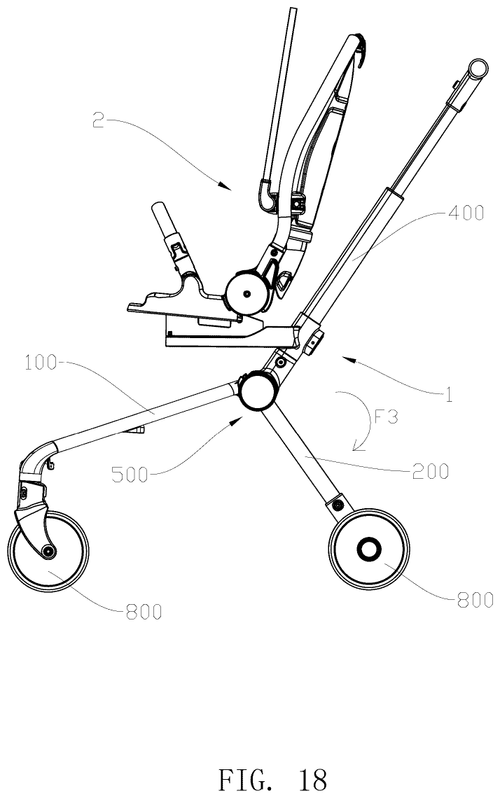

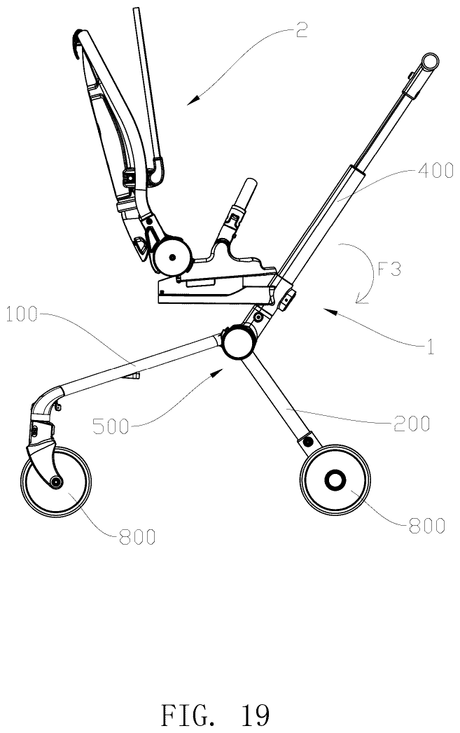

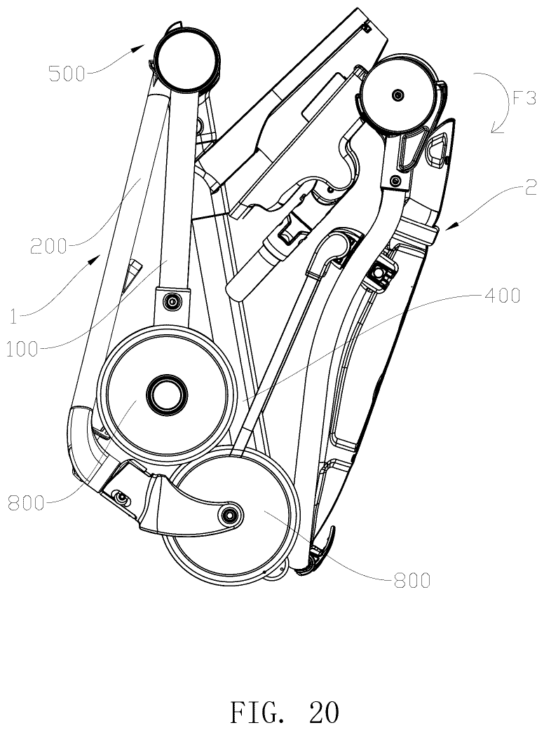

When it is necessary to fold the frame 1, as shown in FIGS. 18 and 19, firstly, an operation is performed to realize the unlocking of the unlocking assembly 520, and then the push rod frame 400 can be rotated in a direction F3, that is, the push rod frame 400 can be moved toward the second wheel frame 200. As shown in FIG. 29, the sun gear 535 fixed on the pivot base 413 also rotates in the direction F3, and drives the planetary gear 537 engaged with the sun gear 535 to rotate in the opposite direction of the direction F3. During the rotation of the planetary gear 537, the rotary plate 536 engaged with the planetary gear 537 is also driven by the toothed edge 5362 to rotate in the opposite direction of the direction F3. That is, the first wheel frame 100 moves towards the push rod frame 400. During the rotation of the planetary gear 537, the second wheel frame 200 is also driven by the driving shaft 534 to rotate in the opposite direction of the direction F3. That is, the second wheel frame 200 moves towards the push rod frame 400. In this way, the push rod frame 400, the first wheel frame 100, and the second wheel frame 200 all rotate and move towards each other to realize the overall folding of the frame 1. When the planetary gear 537 moves from the first end 5363 to the second end 5364 along the toothed edge 5362, the frame 1 is folded into position, as shown in FIG. 20.

When it is necessary to unfold the frame 1, the push rod frame 400 is pushed in the opposite direction of the direction F3, so that the push rod frame 400 is rotated in a direction away from the first wheel frame 100 and the second wheel frame 200. At the same time, as shown in FIG. 29, the sun gear 535 fixed on the pivot base 413 also rotates in the opposite direction of the direction F3, and drives the planetary gear 537 engaged with the sun gear 535 to rotate in the direction F3. During the rotation of the planetary gear 537, the rotary plate 536 engaged with the planetary gear 537 is also driven by the toothed edge 5362 to rotate in the direction F3, that is, the first wheel frame 100 is unfolded in a direction away from the push rod frame 400. During the rotation of the planetary gear 537, the second wheel frame 200 is also driven by the driving shaft 534 to rotate in the direction F3, that is, the second wheel frame 200 is unfolded in the direction away from the push rod frame 400. When the push rod frame 400, the first wheel frame 100, and the second wheel frame 200 are rotated into position, the locking member 521 is inserted into the locking recesses 1125 under the elastic force of the first reset member 524, thereby locking the frame 1 in the unfolded state, as shown in FIGS. 18 and 19.

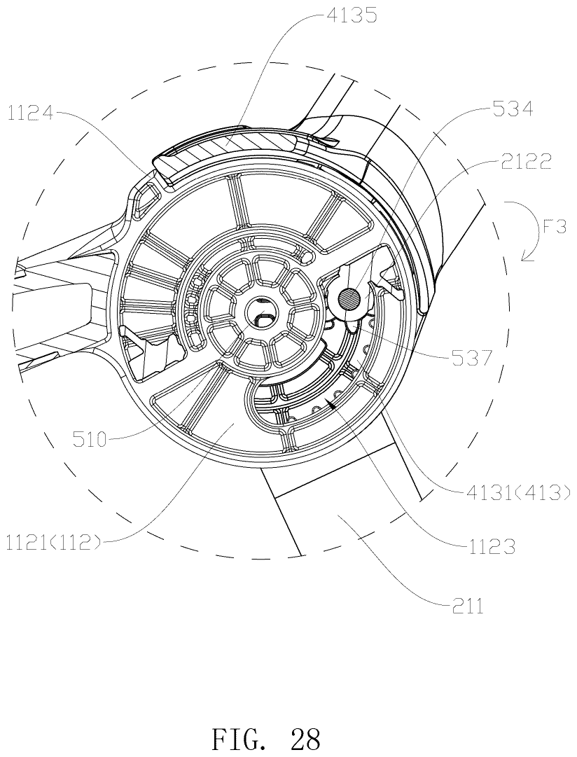

Further, as shown in FIGS. 25, 26 and 28, a front side surface of the pivot base 413 in this embodiment is further provided with a first limiting protrusion 4135. The first pivot part 1121 of each of the two first rotating bases 112 is provided with a second limiting protrusion 1124. Each of the two first rotating bases 112 is provided with a third limiting protrusion 2121. When the frame 1 is unfolded into position, the two second limiting protrusions 1124 and the two third limiting protrusions 2121 abut against the first limiting protrusion 4135, and the first limiting protrusion 4135 is located in front of the two second limiting protrusions 1124 and the two third limiting protrusions 2121 in the direction F3. That is, when the frame 1 is unfolded into position, the two second limiting protrusions 1124, the two third limiting protrusions 2121 and the first limiting protrusion 4135 abut against each other, so that the pivot base 413 is prevented from driving the push rod frame 400 to continue to rotate in the opposite direction of the direction F3, and the frame 1 can be folded only when the push rod frame 400 is rotated in the direction F3. In other embodiments, the second limiting protrusion 1124 capable of abutting against the first limiting protrusion 4135 may be disposed only on the first pivot part 1121 of one of the first rotating bases 112, and the third limiting protrusion 2121 capable of abutting against the first limiting protrusion 4135 may be disposed on one of the second rotating bases 212, which can also provide a limiting protection.

In this embodiment, the linkage assemblies 530 formed by the sun gears 535, the rotary plates 536, the planetary gears 537, and the driving shafts 534 are respectively disposed on both sides of the pivot base 413, so that the push rod frame 400 can synchronously and smoothly drive the first wheel frame 100 and the second wheel frame 200 to rotate and be folded during its rotation. In other embodiments, the folding mechanism 500 may also include only one linkage assembly 530. The sun gear 535, the rotary plate 536, the planetary gears 537, and the driving shaft 534 of this linkage assembly 530 are all located on the same side of the pivot base 413. That is, the push rod frame 400 can drive the first wheel frame 100 and the second wheel frame 200 to rotate and be folded by only one linkage assembly 530.

Further, as shown in FIGS. 1 and 8, the seat locking device 3 may include a seat frame 31. The seat frame 31 is movably disposed on the push rod frame 400. Specifically, the seat frame 31 is movably disposed on the second push rod 412 of the push rod frame 400. The seat assembly 2 is detachably disposed on the seat frame 31 and is configured to provide a sitting space for children. The seat frame 31 can adjust its position on the second push rod 412 by the seat height adjustment mechanism 620. The seat height adjustment mechanism 620 is switchable between a locked state and an unlocked state. When the seat height adjustment mechanism 620 is in the locked state, the seat frame 31 and the second push rod 412 are fixed relative to each other. When the seat height adjustment mechanism 620 is in the unlocked state, the seat frame 31 is movable relative to the second push rod 412.

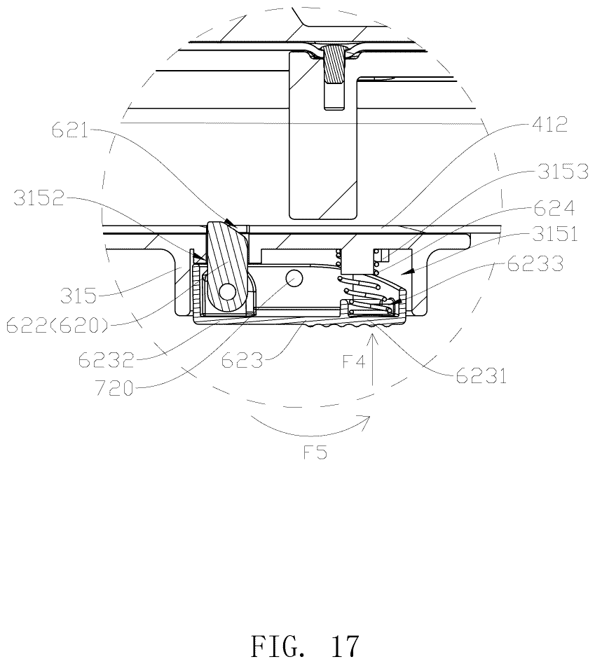

Specifically, as shown in FIGS. 8 and 17, the seat frame 31 may include a support part 311 and a mounting part 315 that are connected to each other. The supporting part 311 is configured to be detachably connected to the seat assembly 2. The mounting part 315 is configured to be movably connected to the second push rod 412. For example, the mounting part 315 can be formed into a sleeve shape to be sleeved outside the second push rod 412, and can move along the second push rod 412. The seat height adjustment mechanism 620 may include a plurality of first locking holes 621 disposed on the second push rod 412, a first locking pin 622 movably disposed on the mounting part 315, a height adjustment operating member 623, and a third reset member 624.

In this embodiment, as shown in FIGS. 8 and 17, the plurality of first locking holes 621 and the plurality of second locking holes 611 are respectively located on opposite sides of the second push rod 412 to avoid the first locking pin 622 and the second locking pin 612 from interfering with each other. The first locking pin 622 is moveable between a third position and a fourth position. When the first locking pin 622 is in the third position, the first locking pin 622 can be inserted into one of the first locking holes 621. When the first locking pin 622 is in the fourth position, the first locking pin 622 can be separated from the first locking hole 621.

Specifically, as shown in FIG. 17, the mounting part 315 is provided with an accommodating groove 3151 with an opening facing away from the second push rod 412. The height adjustment operating member 623 is disposed in the accommodating groove 3151. The two ends of the height adjustment operating member 623 are referred to as an operating end 6231 and a pivot end 6232 respectively. At least the operating end 6231 of the height adjustment operating member 623 is exposed from the rabbet of the accommodating groove 3151 so as to be operated. The base of the accommodating groove 3151 is provided with a through hole 3152 in communication with an inner cavity of the mounting part 315. A first end of the first locking pin 622 is pivotally connected to the pivot end 6232 of the height adjustment operating member 623, and a second end of the first locking pin 622 can extend through the through hole 3152 and be inserted into any one of the first locking holes 621 on the second push rod 412, so that the seat height adjustment mechanism 620 is in the locked state, and the seat frame 31 is fixed in a certain height position relative to the second push rod 412. A substantially middle portion of the height adjustment operating member 623 is pivotally connected to the groove wall of the accommodating groove 3151 by a pivoting member 720. Two ends of the third reset member 624 respectively abut against the height adjustment operating member 623 and the seat frame 31. The third reset member 624 is adapted to bias the height adjustment operating member 623 to move the first locking pin 622 to the third position. Specifically, the surface of the operating end 6231 of the height adjustment operating member 623 facing the accommodating groove 3151 is provided with an abutting groove 6233, a mounting post 3153 facing the abutting groove 6233 is disposed on the base of the accommodating groove 3151. A first end of the third reset member 624 is inserted into the abutting groove 6233 and abuts against the base of the abutting groove 6233. A second end of the third reset member 624 is sleeved outside the mounting post 3153 and abuts against the base of the accommodating groove 3151. Such an arrangement is helpful to prevent the third reset member 624 from being displaced during the deformation process. In this embodiment, the operating end 6231 and the pivot end 6232 of the height adjustment operating member 623 are respectively located on two sides of the pivot member 720. The operating end 6231 is located on the side of the pivot end 6232 adjacent to the handle part 423. That is, in the height direction of the second push rod 412, the third reset member 624 is disposed on the relatively upper side of the first locking pin 622.

The working principle of the above-mentioned seat height adjustment mechanism 620 is as follows.

When it is necessary to adjust the height of the seat assembly 2 by the seat height adjustment mechanism 620, as shown in FIG. 17, the height adjustment operating member 623 can be pressed in a direction F4, the third reset member 624 is compressed and deformed, and the height adjustment operating member 623 pivots in the direction F5, and simultaneously drives the first locking pin 622 pivotally connected to the height adjustment operating member 623 to move in the opposite direction of the direction F4. When the first locking pin 622 moves to the fourth position and separates from the first locking hole 621, the seat height adjustment mechanism 620 switches from the locked state to the unlocked state, and the seat frame 31 can move relative to the second push rod 412 to change the height of seat assembly 2. When the seat frame 31 moves to the required height position relative to the second push rod 412, the pressing force applied on the height adjustment operating member 623 is removed, and then the height adjustment operating member 623 moves in the opposite direction of the direction F5 and drives the first locking pin 622 pivotally connected to the height adjustment operating member 623 to move in the direction F4 under the elastic force of the second reset member 527. When the first locking pin 622 moves to the third position and is inserted into another of the first locking holes 621, the seat height adjustment mechanism 620 switches from the unlocked state to the locked state, and the seat frame 31 is fixed in the required height position relative to the second push rod 412, that is, the seat assembly 2 is adjusted to the required height.

In addition, the seat locking device 3 according to the present application can realize the rotation of the seat assembly 2 relative to the frame, for example, realize the 360-degree rotation reversal of the seat assembly 2 relative to the frame. In addition, the seat locking device 3 enables rapid detachment of the seat assembly 2 from the frame 1. The seat locking device 3 is detachably connected to the push rod frame 400.

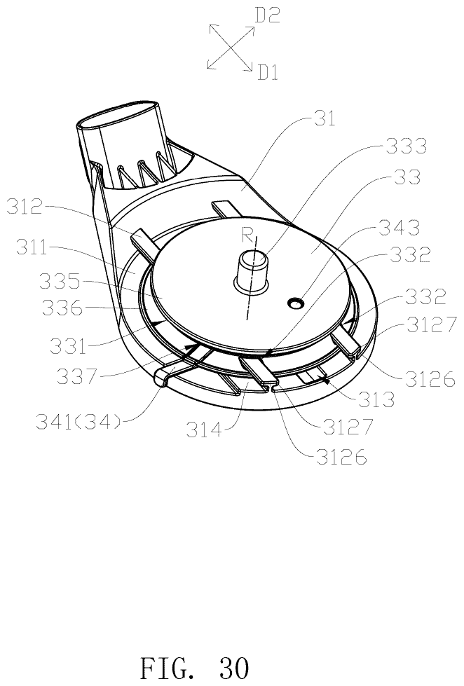

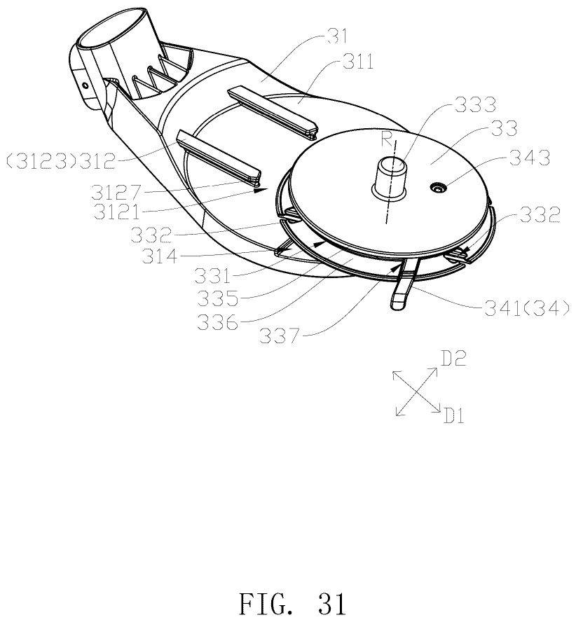

As shown in FIGS. 4 and 30, the seat locking device 3 may further include a connecting base 32, a movable base 33, and a first locking mechanism 34. The connecting base 32 is disposed on the seat assembly 2. The connecting base 32 is movably connected to the seat frame 31 by the movable base 33. As shown in FIGS. 30 and 31, the connecting base 32 has a first moving position and a second moving position. When the connecting base 32 is in the first moving position, the connecting base 32 cannot rotate relative to the seat frame 31. When the base 32 is in the second moving position, the connecting base 32 is rotatable relative to the seat frame 31. The first locking mechanism 34 is switchable between an unlocked state and a locked state, so that the connecting base 32 can rotate relative to the seat frame 31 or the connecting base 32 can be fixed at a desired rotating angle relative to the seat frame 31. As such, the reversal and positioning of the seat assembly 2 can be realized. Specifically, when the first locking mechanism 34 is in the unlocked state, the movable base 33 can drive the connecting base 32 to move relative to the seat frame 31, so that the connecting base 32 is moved between the first moving position and the second moving position relative to the seat frame 31. When the connecting base 32 is moved to the second moving position, the connecting base 32 is rotatable relative to the seat frame 31, around a rotation axis R, thereby realizing the reversal of the seat assembly 2. When the first locking mechanism 34 is in the locked state, the movable base 33 cannot move relative to the seat frame 31, so that the connecting base 32 cannot move relative to the seat frame 31. In this case, if the connecting base 32 is in the first moving position, the connecting base 32 cannot rotate relative to the seat frame 31, so that the connecting base 32 is fixed relative to the seat frame 31, and thus the seat assembly 2 is fixed at a desired rotating angle.

In some other unillustrated embodiments, the seat locking device 3 may not include the movable base 33. The connecting base 32 is directly connected to the seat frame 31. The first locking mechanism 34 enables the connecting base 32 to rotate relative to the seat frame 31 or to fix the connecting base 32 relative to the seat frame 31. Specifically, when the first locking mechanism 34 is in the unlocked state, the connecting base 32 is movable between the first moving position and the second moving position relative to the seat frame 31. When the connecting base 32 moves to the second moving position, the connecting base 32 can rotate relative to the seat frame 31, thereby realizing the reversal of the seat assembly 2. When the first locking mechanism 34 is in the locked state, the connecting base 32 cannot move relative to the seat frame 31. In this case, if the connecting base 32 is in the first moving position, the connecting base 32 cannot rotate relative to the seat frame 31, so that the connecting base 32 can be fixed relative to the seat frame 31, and thus the seat assembly 2 is fixed at a desired rotating angle.

As shown in FIG. 4, and FIGS. 30 to 32, the seat frame 31 is movably connected to the push rod frame 400 of the frame 1. On the support part 311 of the seat frame 31, the movable base 33 and the connecting base 32 are movably connected. The support part 311 of the seat frame 31 has a substantially circular cross-section. The support part 311 is provided with a guide rail 312 and a third receiving groove 313. The third receiving groove 313 extends in a front-back direction. An extending line of the third receiving groove 313 intersects with the rotation axis R. It should be noted that the front and back in this embodiment respectively refer to the directions in which the stroller moves forward or backward during moving.

As shown in FIGS. 30 to 32 and FIG. 35, the guide rail 312 is adapted to be engaged with the movable base 33 and the connecting base 32. A surface of the connecting base 32 facing the seat frame 31 is correspondingly provided with a first guide groove 321 capable of being engaged with the guide rail 312. When the connecting base 32 is in the first moving position, the first guide groove 321 is engaged with the guide rail 312 so that the connecting base 32 cannot rotate relative to the seat frame 31. When the connecting base 32 is in the second moving position, the first guide groove 321 is disengaged from the guide rail 312 so that the connecting base 32 is rotatable relative to the seat frame 31.

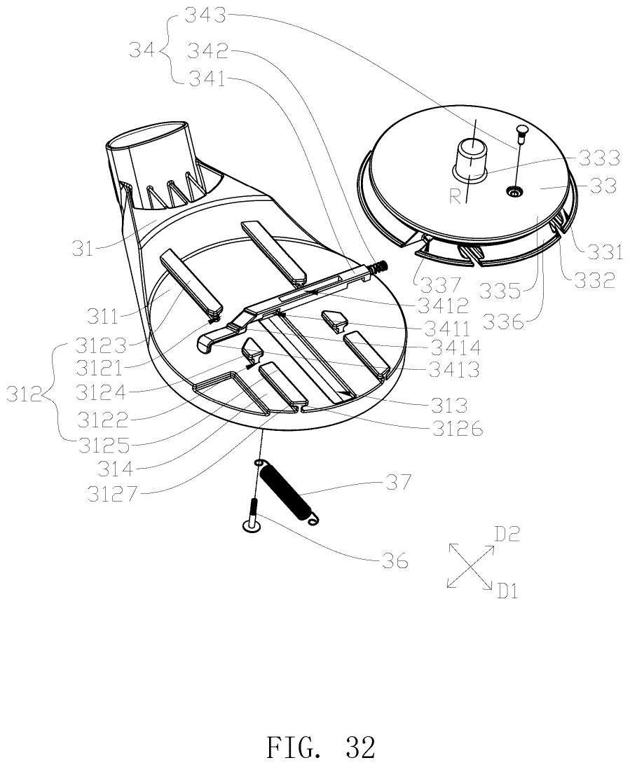

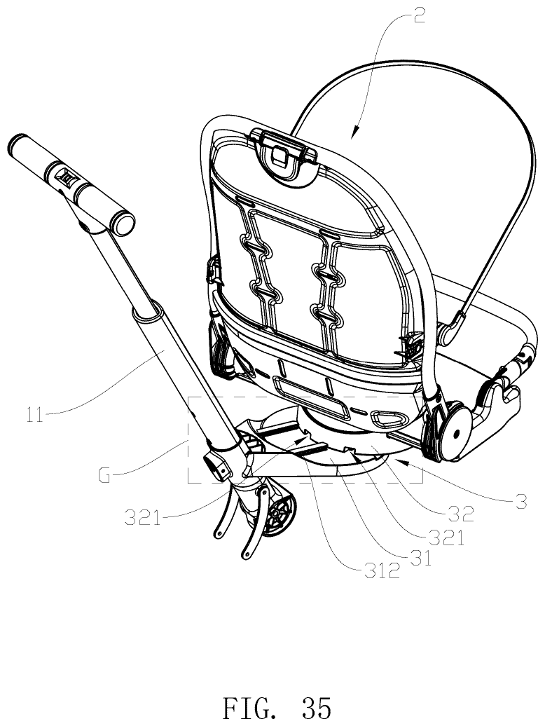

Further, as shown in FIGS. 32 and 35, the cross section of the guide rail 312 is generally T-shaped to limit the movable base 33 or the connecting base 32 to the guide rail 312. The guide rail 312 is provided with a rotation notch 3121 configured for the connecting base 32 to rotate and a switching notch 3122 configured for the first locking mechanism 34 to switch between the unlocked state and the locked state. The guide rail 312 includes a first section 3123, a third section 3124, and a second section 3125 extending in the same direction. That is, the first section 3123, the third section 3124 and the second section 3125 are all located on the same straight line. The first section 3123 and the third section 3124 are spaced apart to rotation notch 3121. The third section 3124 and the second section 3125 are spaced apart to form the switching notch 3122. An end of the second section 3125 away from the third section 3124 forms an outer end 3126 of the guide rail 312. As shown in FIG. 31 or 35, when the connecting base 32 is in the second moving position, the first guide groove 321 can be located at the rotation notch 3121 or at a side of the second section 3125 of the guide rail 312 away from the rotation notch 3121. That is, when the first guide groove 321 is located at the rotation notch 3121, the first guide groove 321 is disengaged from the guide rail 312, thereby allowing the connecting base 32 to rotate relative to the seat frame 31. The end of the first section 3123 facing the third section 3124 has a chamfer or rounded corner 3127, so that the first guide groove 321 can automatically adjust its rotating angle and be engaged with the guide rail 312 when there is a slight angular deviation between the first guide groove 321 and the guide rail 312. That is, the first guide groove 321 and the guide rail 312 can be automatically aligned with each other when there is a slight angular deviation therebetween. The outer end 3126 has a chamfer or rounded corner 3127 accordingly, so that the first guide groove 321 and the guide rail 312 can be automatically aligned with each other when there is a slight angular deviation therebetween.

As shown in FIGS. 32 and 35, the extending direction of the guide rail 312 is parallel to the extending direction of the third receiving groove 313, that is, the guide rail 312 extends in the front-back direction. In this embodiment, two guide rails 312 are provided. The two guide rails 312 are symmetrically arranged with respect to the rotation axis R of the connecting base 32, so that the movable base 33 and the connecting base 32 can move smoothly along the guide rails 312. In some other unillustrated embodiments, one, three, or even more guide rails 312 may be provided, as long as the guide rails 312 can move the connecting base 32 between the first moving position and the second moving position relative to the seat frame 31, and which is not limited in the present application.

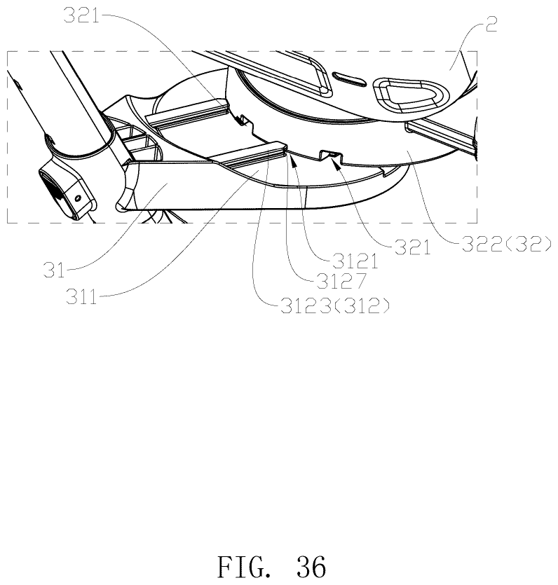

In an embodiment, as shown in FIGS. 32 to 35, the movable base 33 includes a truncated cone part 336 and a disc-shaped part 335. The outer peripheral contour of the truncated cone part 336 is tapered or substantially tapered. The disc-shaped part 335 is connected to a first end of the truncated cone part 336. An engaging groove 331 is formed at the connection between the disc-shaped part 335 and the truncated cone part 336. The engaging groove 331 is configured to be engaged with the second locking mechanism 35, to detachably connect the connecting base 32 to the movable base 33. For the specific configuration of the second locking mechanism 35, reference may be made to the description below. A second end of the truncated cone part 336 away from the disc-shaped part 335 is provided with a second guide groove 332 that can be engaged with the guide rail 312 to guide the movable base 33 to slide along the guide rail 312. The movable base 33 includes an accommodating cavity 334. At least a portion of the first locking mechanism 34 is received in the accommodating cavity 334. The second guide groove 332 is in communication with the accommodating cavity 334, so that when the second guide groove 332 is engaged with the guide rail 312, a portion of the guide rail 312 is received in the accommodating cavity 334, so that the first locking mechanism 34 can avoid the guide rail 312 or interfere with the guide rail 312, to achieve switching between the unlocked state and the locked state. When the first locking mechanism 34 is in the locked state, at least a portion of the first locking mechanism 34 abuts against the guide rail 312, so that the second guide groove 332 cannot move in a direction parallel to the guide rail 312 (that is, in the first direction D1) relative to the guide rail 312. As such, neither the first locking mechanism 34 nor the movable base 33 can move in the first direction D1 relative to the guide rail 312 (or the seat frame 31), so that the connecting base 32 cannot move in the first direction D1 relative to the guide rail 312 (or the seat frame 31). When the first locking mechanism 34 is in the unlocked state, the first locking mechanism 34 does not interfere with the relative sliding between the second guide groove 332 and the guide rail 312, so that the first locking mechanism 34 and the movable base 33 can moves relative to the guide rail 312 (or the seat frame 31) in the first direction D1, thereby driving the connecting base 32 to move in the first direction D1 relative to the seat frame 31, between the first moving position and the second moving position. When the connecting base 32 moves to the second moving position, the connecting base 32 can rotate relative to the seat frame 31 (as shown in FIGS. 35 and 36).

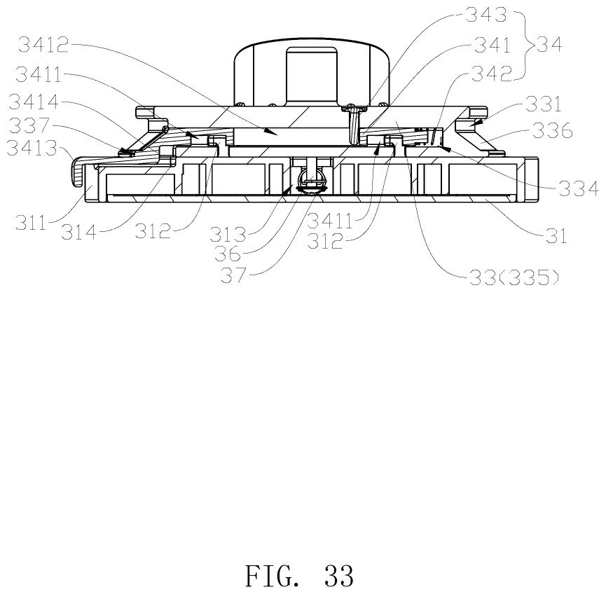

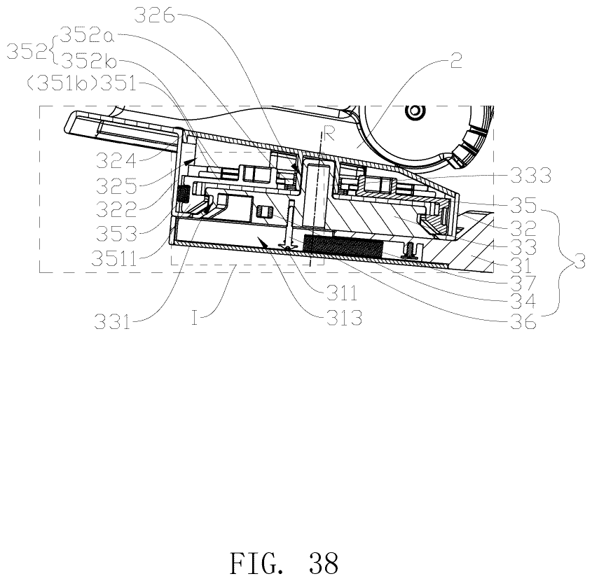

Further, as shown in FIGS. 32 and 38, the movable base 33 is provided with a connecting shaft 333. The connecting shaft 333 is adapted to be connected to the connecting base 32 to provide the rotation axis R about which the connecting base 32 is rotatable with respect to the movable base 33. The connecting base 32 is correspondingly provided with a first insertion hole 326. The connecting shaft 333 is inserted into the first insertion hole 326. The movable base 33 is connected to the seat frame 31 by a movable post 36. As shown in FIG. 33, a first end of the movable post 36 is connected to the movable base 33, and a second end of the movable post 36 is inserted into the third receiving groove 313 and is movable in the third receiving groove 313. The movable post 36 is offset from the rotation axis R of the connecting base 32. In this embodiment, the movable post 36 includes screws, bolts, etc. Optionally, the first end of the movable post 36 can be threadedly connected to the movable base 33.

In an embodiment, as shown in FIGS. 32 and 38, the seat locking device 3 may further include a moving reset member 37. The moving reset member 37 is connected to the movable post 36 and the seat frame 31. The moving reset member 37 is adapted to bias the movable post 36 to move the movable base 33, thereby driving the connecting base 32 to move towards the first moving position. The moving reset member 37 includes a spring. Specifically, the moving reset member 37 includes a tension spring. A first end of the moving reset member 37 is connected to the groove wall of the third receiving groove 313, and a second end of the moving reset member 37 is connected to the movable post 36.

In an embodiment, as shown in FIGS. 32 to 34, the first locking mechanism 34 includes a reversing unlocking member 341, a reversing reset member 342, and a positioning pin 343. The reversing unlocking members 341 are at least partially disposed in the accommodating cavity 334. The reversing unlocking member 341 is intersected with the guide rail 312. The reversing unlocking member 341 can move in the second direction D2 relative to the movable base 33, so as to be switchable between a reversing unlocked position and a reversing locked position, that is, to enable the first locking mechanism 34 to be switchable between a locked state and an unlocked state. The second direction D2 intersects with the extending direction of the guide rail 312, that is, the second direction D2 intersects with the first direction D1, and is perpendicular to the rotation axis R of the connecting base 32. In this embodiment, the second direction D2 and the first direction D1 are perpendicular to each other. The reversing unlocking member 341 is also movable in the first direction D1 relative to the seat frame 31, so that the movable base 33 is movable relative to the seat frame 31 and drives the connecting base 32 to move between the first moving position and the second moving position.

In an embodiment, as shown in FIGS. 32 to 34, the reversing unlocking member 341 includes a first recess 3411. The first recess 3411 is located in the accommodating cavity 334 and can cooperate with the guide rail 312. The guide rail 312 is movable along the first recess 3411. The cross-sectional shape of the first recess 3411 is consistent with the cross-sectional shape of the guide rail 312, or the guide rail 312 can be completely located within the first recess 3411. For example, the cross section of the guide rail 312 is T-shaped. Correspondingly, the cross section of the first recess 3411 can be a T-shaped or rectangular, so that the guide rail 312 can run through the first recess 3411 so that the reversing unlocking member 341 can move in the first direction D1 relative to the guide rail 312.

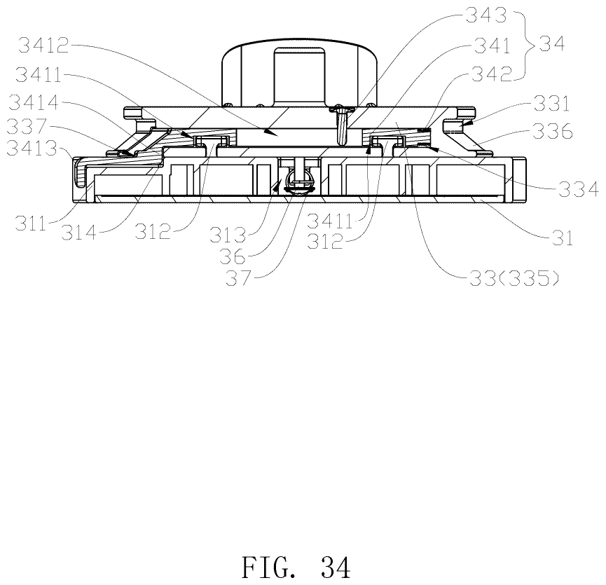

As shown in FIGS. 30 to 32, when the connecting base 32 is in the first moving position, the reversing unlocking member 341 is inserted into the switching notch 3122 of the guide rail 312. The reversing unlocking member 341 moves towards a direction intersecting with the extending direction of the guide rail 312 relative to the guide rail 312. That is, in this embodiment, the reversing unlocking member 341 can move in the second direction D2 to switch between the reversing unlocked position and the reversing locked position. When the reversing unlocking member 341 is in the reversing unlocked position, the first recess 3411 and the guide rail 312 (specifically, the third section 3124 and the second section 3125) are aligned with each other in the direction D1 (as shown in FIG. 34). The guide rail 312 and the first recess 3411 of the reversing unlocking member 341 is aligned with each other so that the reversing unlocking member 341 can move in the first direction D1 relative to the guide rail 312, and thus the movable base 33 and the connecting base 32 is movable in the first direction D1 relative to the seat frame 31. When the reversing unlocking member 341 is in the reversing locked position, the first recess 3411 and the guide rail 312 (specifically, the third section 3124 and the second section 3125) are at least partially staggered from each other in the direction D1 (as shown in FIG. 33). Both sides of the reversing unlocking member 341 abut against the third section 3124 and the second section 3125 respectively, so that the reversing unlocking member 341 cannot move in the first direction D1 relative to the guide rail 312, and thus the movable base 33 and the connecting base 32 cannot move in the first direction D1 relative to the seat frame 31. When the connecting base 32 is in the second moving position, the reversing unlocking member 341 is located on the side of the second section 3125 away from the rotation notch 3121. In this case, if the pushing force applied on the reversing unlocking member 341 is maintained, the reversing unlocking member 341 remains in the reversing unlocked. Alternatively, in other embodiments, a limiting component (not shown) can also be provided in the third receiving groove 313 to limit the forward movement of the movable post 36, so that when the movable post 36 moves to abut against the limiting component, the connecting base 32 is in the second moving position, and at this time, the first recess 3411 of the reversing unlocking member 341 is in a position of the guide rail 312 away from the switching notch 3122. That is, the first recess 3411 is engaged with the second section 3125 of the guide rail 312, so that even when the pushing force applied on the reversing unlocking member 341 is removed, the reversing unlocking member 341 is still in the reversing unlocked position and cannot move from the reversing unlocked position to the reversing locked position. Correspondingly, two first recesses 3411 are provided. The two guide rails 312 can run through the two first recesses 3411 respectively.

In other unillustrated embodiments, the guide rail 312 includes the first section 3123 and the second section 3125 extending in the same direction. That is, the first section 3123 and the second section 3125 are both located on the same straight line. The first section 3123 and the third section 3124 are spaced apart to form the rotation notch 3121 or the switching notch 3122. In this embodiment, the rotation notch 3121 and the switching notch 3122 are the same component. When the connecting base 32 is in the first moving position, the reversing unlocking member 341 is inserted into the switching notch 3122 of the guide rail 312, and the reversing unlocking member 341 moves relative to the guide rail 312 in a direction intersecting with the extending direction of the guide rail 312. That is, in this embodiment, the reversing unlocking member 341 can move in the second direction D2 to switch between the reversing unlocked position and the reversing locked position. When the reversing unlocking member 341 is in the reversing unlocked position, the first recess 3411 and the guide rail 312 (specifically, the third section 3124 and the second section 3125) are aligned with each other in the direction D1 (as shown in FIG. 34). The guide rail 312 is aligned with the first recess 3411 of the reversing unlocking member 341, so that the reversing unlocking member 341 can move relative to the guide rail 312 in the first direction D1, and thus the movable base 33 and the connecting base 32 are movable relative to the seat frame 31 in the first direction D1. When the reversing unlocking member 341 is in the reversing locked position, the first recess 3411 and the guide rail 312 (specifically, the third section 3124 and the second section 3125) are at least partially staggered from each other in the direction D1 (as shown in FIG. 33). A side of the reversing unlocking member 341 abuts against the second section 3125, so that the reversing unlocking member 341 cannot move away from the first section 3123 in the first direction D1 relative to the guide rail 312, and thus the movable base 33 and the connecting base 32 cannot move in the first direction D1 relative to the seat frame 31. When the connecting base 32 is in the second moving position, the first guide groove 321 is located on the side of the second section 3125 of the guide rail 312 away from the rotation notch 3121, or at the rotation notch 3121, so that the first guide groove 321 is disengaged from the guide rail 312, and thus the connecting base 32 is rotatable relative to the seat frame 31.

As shown in FIGS. 32 to 34, the reversing unlocking member 341 is provided with a strip-shaped positioning groove 3412. An extending direction of the positioning groove 3412 is parallel to the second direction D2. The positioning pin 343 is inserted into the positioning groove 3412, so that the reversing unlocking member 341 is movable relative to the positioning pin 343 in the second direction D2, and movable in the first direction D1 in synchronization with the positioning pin 343. In this embodiment, a first end of the positioning pin 343 is connected to the movable base 33. Specifically, the positioning pin 343 is detachably connected to the disc-shaped part 335 of the movable base 33. In some other embodiments where the movable base 33 is not provided, for example, a second end of the positioning pin 343 can be movably connected to the seat frame 31, so that the positioning pin 343 is movable in the first direction D1 relative to the seat frame 31, but immovable in the second direction D2, the second end of the positioning pin 343 is inserted into the positioning groove 3412.

Further, as shown in FIGS. 32 to 34, the reversing unlocking member 341 includes a reversing operating part 3413. The movable base 33 is provided with a through opening 337 that extending through the wall of the accommodating cavity 334. The reversing operating part 3413 of the reversing unlocking member 341 extends out of the accommodating cavity 334 via the through opening 337 to facilitate operation of the reversing unlocking member 341. The reversing unlocking member 341 further includes a limiting member 3414. A limiting convex part 314 is formed on the surface of the seat frame 31 facing the connecting base 32. The limiting member 3414 can abut against the limiting convex part 314 to limit the movement of the reversing unlocking member 341 in the second direction D2.

As shown in FIGS. 32 to 34, the reversing reset member 342 is received in the accommodating cavity 334. The reversing reset member 342 is adapted to bias the reversing unlocking member 341 to move towards the reversing locked position. The reversing reset member 342 includes elastic members such as springs and elastic pieces. A first end of the reversing reset member 342 abuts against the wall of the accommodating cavity 334, and a second end of the reversing reset member 342 abuts against the reversing unlocking member 341.

In an example, as shown in FIGS. 36, 38 and 39, the connecting base 32 includes a first housing 322 and a second housing 324. The first housing 322 includes a third groove 323. The third groove 323 faces the movable base 33 (or seat frame 31). The shape of the third groove 323 is adapted to the outer peripheral contour of the movable base 33. The first insertion hole 326 is defined at the base of the third groove 323. At least a portion of the movable base 33 is received in the third groove 323, so that the movable base 33 is engaged with the connecting base 32, and is inserted into the first insertion hole 326 by the connecting shaft 333. For example, a portion of the disc-shaped part 335 and a portion of the truncated cone part 336 of the movable base 33 are received in the third groove 323. The second housing 324 is connected to the seat assembly 2. Optionally, the second housing 324 is fixedly connected to the seat assembly 2. The second housing 324 and the first housing 322 enclose a receiving chamber 325. The receiving chamber 325 is in communication with the third groove 323.

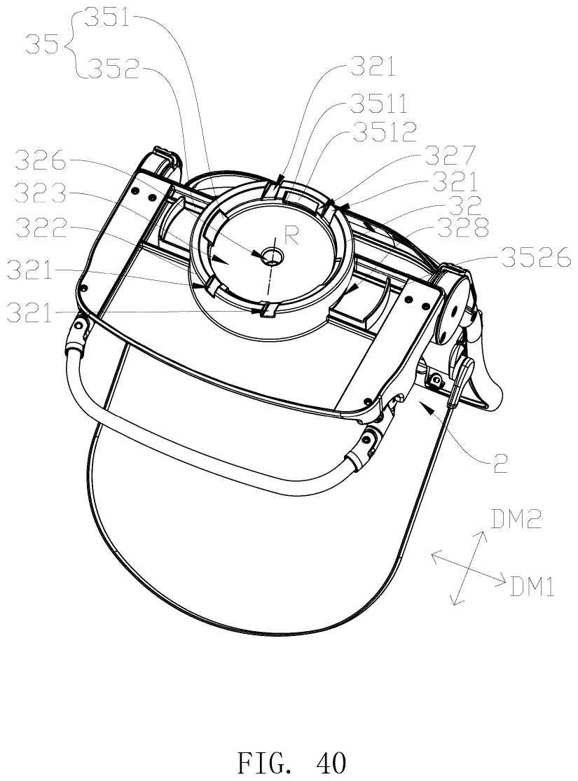

As shown in FIGS. 36 and 40, the first guide groove 321 and the third groove 323 are located on the same surface of the connecting base 32. At least two first guide grooves 321 are provided, and the number of the first guide grooves 321 may be a multiple of two. For example, two, four, six, eight, or more first guide grooves 321 may be provided. The number of first guide grooves 321 depends on the number of guide rails 312 and the angle at which the connecting base 32 (or the seat assembly 2) needs to be rotated. In this embodiment, two guide rails 312 are provided, and four first guide grooves 321 are provided. In this embodiment, the third groove 323 is generally circular, and the four first guide grooves 321 are circumferentially disposed on the sidewall of the third groove 323. The four first guide grooves 321 are distributed centrally symmetrically with respect to the rotation axis R. The extending directions of every two first guide grooves 321 are the same as the extending direction of the corresponding guide rail 312. That is, at least two first guide grooves 321 whose extending directions coincide with each other are referred to as the same group of first guide grooves 321. In this embodiment, the four first guide grooves 321 can be divided into two groups of first guide grooves 321. The extending directions of the two groups of first guide grooves 321 are parallel to each other. Each group of first guide rails 312 includes two first guide rails 312. When the connecting base 32 is in the second moving position, one of each group of the first guide grooves 321 is located at the rotation notch 3121, and another of each group of the first guide grooves 321 is located on the side of the second section 3125 of the guide rail 312 away from the rotation notch 3121. In this case, the first guide groove 321 is disengaged from the guide rail 312, so that the connecting base 32 can rotate relative to the movable base 33. When the connecting base 32 rotates by 180 degrees, the first guide groove 321 of each group of the first guide grooves 321 located at the outer end 3126 of the second section 3125 rotates to the rotation notch 3121. When the connecting base 32 moves from the second moving position back to the first moving position, the connecting base 32 is engaged with the first section 3123 of the guide rail 312, and the first guide groove 321 of each group of the first guide grooves 321 located at the rotation notch 3121 rotates to the side of the second section 3125 of the guide rail 312 away from the rotation notch 3121. When the connecting base 32 moves from the second moving position to the first moving position, the connecting base 32 is engaged with the second section 3125 of the guide rail 312.

In other unillustrated embodiments, an odd number of the first guide grooves 321 may also be provided, for example, one, three, five, or seven first guide grooves 321 may also be provided. The first guide grooves 321 are circumferentially disposed on the sidewall of the third groove 323. Herein, an embodiment in which one first guide groove 321 is provided is given for description. When the connecting base 32 is in the first moving position, the first guide groove 321 is engaged with, for example, the first section 3123 or the second section 3125 of one of the guide rails 312. When the connecting base 32 moves to the second moving position, the first guide groove 321 is located in the rotation notch 3121 and disengaged from the first section 3123, or the first guide groove 321 is located on a side of the second section 3125 of the guide rail 312 away from the rotation notch 3121 to be disengaged from the second section 3125. In this case, the connecting base 32 can rotate relative to the movable base 33. When the connecting base 32 rotates by 180 degrees relative to the movable base 33, the first guide groove 321 rotates from the rotation notch 3121 to the side of the second section 3125 of the guide rail 312 away from the rotation notch 3121, or the first guide groove 321 rotates from the side of the second section 3125 of the guide rail 312 away from the rotation notch 3121 to the rotation notch 3121. During the connecting base 32 moving from the second moving position to the first moving position, the first guide groove 321 is engaged with the second section 3125 of the guide rail 312, or the first guide groove 321 is engaged with the first section 3123 to guide the connecting base 32 to move along the guide rail 312.

In other embodiments, when it is desired to rotate the connecting base 32 to different angles, that is, when it is desired to fix the connecting base 32 at different reversing angles, a plurality of first guide grooves 321 can be disposed on the connecting base 32. The plurality of first guide grooves 321 are distributed circumferentially on the sidewalls of the third groove 323.

An embodiment in which four first guide grooves 321 are provided is given for illustration, and the principle of reversal of the seat assembly 2 in the embodiment of the present application is as follows.

When the connecting base 32 is in the first moving position, as shown in FIG. 30, the reversing unlocking member 341 is pushed to move from the reversing locked position to the reversing unlocked position, as shown in FIGS. 32 and 34. In this case, the first recess 3411 of the reversing unlocking member 341 is located at the switching notch 3122 of the guide rail 312, allowing the guide rail 312 to run through the first recess 3411 and allowing the reversing unlocking member 341 to move in the second direction D2 relative to the guide rail 312. In this case, the seat assembly 2, the connecting base 32 or the movable base 33 can be pushed such that the connecting base 32 together with the movable base 33 and the seat assembly 2 are moved to the second moving position, and the movable post 36 is driven to move in the third receiving groove 313 accordingly. At this time, two of the first guide grooves 321 on the connecting base 32 move to the rotation notch 3121, and the remaining two first guide grooves 321 on the connecting base 32 move to the side of the second section 3125 of the guide rail 312 away from the rotation notch 3121. In this case, all the first guide grooves 321 are disengaged from the guide rails 312, so that the connecting base 32 can rotate by 360 degrees relative to the movable base 33. When the connecting base 32 is in the second moving position, the seat assembly 2 or the connecting base 32 can be pushed to rotate by 180 degrees or other desired angles relative to the movable base 33, so that each group of first guide grooves 321 and the corresponding guide rail 312 are located in the same straight line, and thus the first guide groove 321 can be re-engaged with the guide rail 312. In this case, when the external force applied on the seat assembly 2 or the connecting base 32 is removed, under the action of the elastic restoring force of the moving reset member 37, the movable post 36 moves towards an initial position before the reversing unlocking member 341 is pushed or pulled, and drives the connecting base 32 by the movable base 33, to move along the guide rail 312. When the connecting base 32 moves to the first moving position, the first recess 3411 of the reversing unlocking member 341 is located at the switching notch 3122, so that the reversing unlocking member 341 can move in the second direction D2 relative to the guide rail 312. In this case, when the external pushing force applied on the reversing unlocking member 341 is removed, under the elastic restoring force of the reversing reset member 342, the reversing unlocking member 341 moves from the reversing unlocked position to the reversing locked position, to fix the connecting base 32 at the reversed angle.

When the above-mentioned seat assembly 2 is reversed, the seat assembly 2 can firstly move from the first moving position relatively backward to the second moving position relatively forward, which can avoid interference between the child's legs and the push rod frame 400 when reversing, thereby enabling the reversal of the seat assembly 2 to be directly performed when the child rides on the seat assembly 2 without getting off the seat assembly 2.

In an embodiment, as shown in FIG. 38, the seat locking device 3 further includes a second locking mechanism 35. The connecting base 32 is detachably connected to the movable base 33 by the second locking mechanism 35. The second locking mechanism 35 is disposed on the connecting base 32. The second locking mechanism 35 includes a separation locking member 351, a separation unlocking member 352, and a separation reset member 353. The separation locking member 351 can be engaged with the engaging groove 331 of the movable base 33 as described above. The separation unlocking member 352 is drivingly connected to the separation locking member 351. The separation unlocking member 352 is operable to disengage the separation locking member 351 from the engaging groove 331.

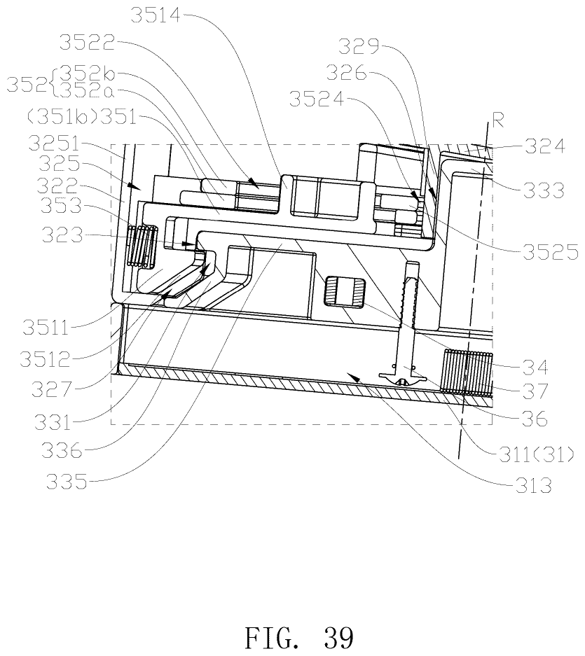

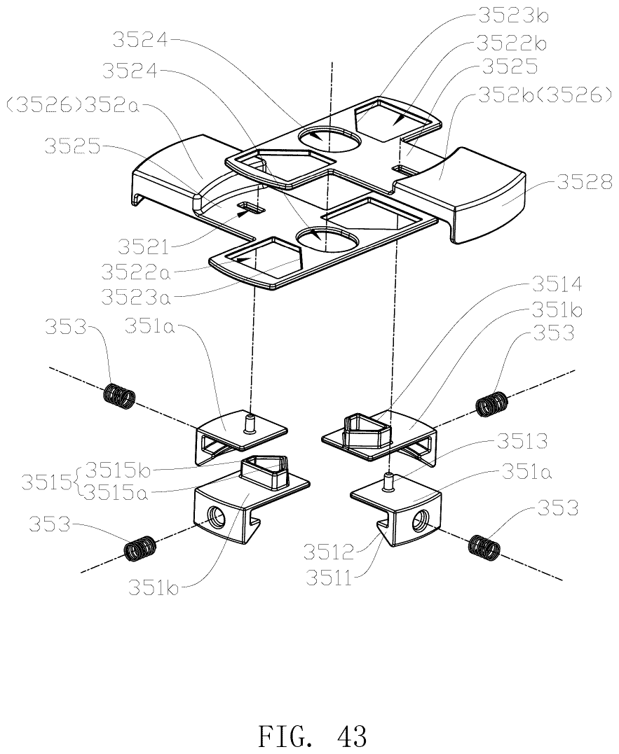

As shown in FIGS. 39 and 43, the separation locking member 351 is movably disposed on the connecting base 32 and includes a hook part 3511. The connecting base 32 is further provided with a first opening 327. The third groove 323 is in communication with the receiving chamber 325 through the first opening 327. At least a portion of the separation locking member 351 is received in the receiving chamber 325. The hook part 3511 of the separation locking member 351 can extend through the first opening 327 to be engaged with the engaging groove 331. The separation locking member 351 is switchable between a separation locked position and a separation unlocked position. When the separation locking member 351 is in the separation locked position, the hook part 3511 can extend out of the first opening 327 to be engaged with the engaging groove 331. When the separation locking member 351 is in the separation unlocked position, the hook part 3511 can withdraw from the engaging groove 331 to be disengaged from the engaging groove 331. The separation locking member 351 further includes a wedge-shaped surface 3512. The wedge-shaped surface 3512 is located on the hook part 3511. The wedge-shaped surface 3512 is adapted to be pushed by the movable base 33 so that the separation locking member 351 moves from the separation locked position to the separation unlocked position. The disc-shaped part 335 of the movable base 33 can move along the wedge-shaped surface 3512, cross over the hook part 3511, and move to be between the hook part 3511 and the base of the third groove 323. Then, the separation locking member 351 which is not pushed by the movable base 33 moves to the separation locked position (described in detail below), and is automatically engaged with the engaging groove 331, under the elastic force of the separation reset member 353.

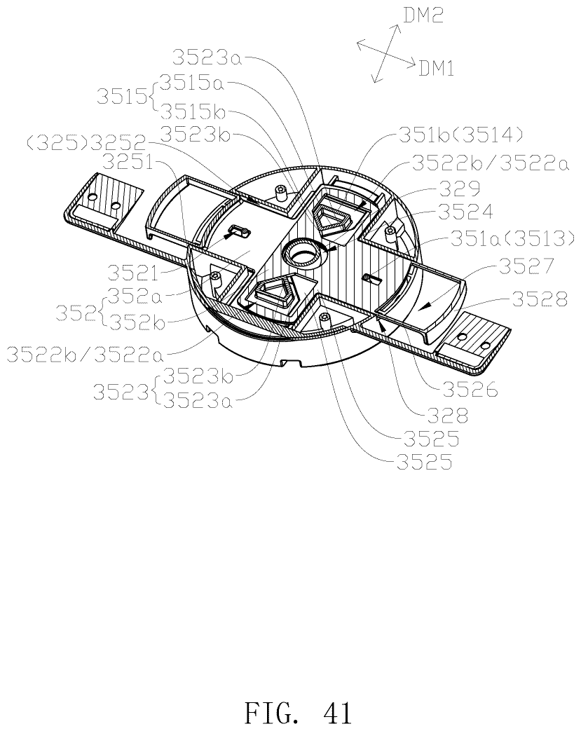

Further, as shown in FIGS. 41 and 43, the separation locking member 351 includes a first separation locking member 351a and a second separation locking member 351b. The first separation locking member 351a is provided with a first protrusion 3513. The first protrusion 3513 is adapted to be drivingly connected to the separation unlocking member 352, to drive the separation locking member 351 to move. The second separation locking member 351b is provided with a second protrusion 3514. A side surface of the second protrusion 3514 forms a locking driving surface 3515. The locking driving surface 3515 is adapted to be drivingly connected to the separation unlocking member 352, to drive the second separation locking member 351b to move. A first moving direction DM1 of the first separation locking member 351a is arranged at an angle to a second moving direction DM2 of the second separation locking member 351b. Two first separation locking members 351a are provided. The two first separation locking members 351a are symmetrically distributed with respect to the rotation axis R of the connecting base 32. Two second separation locking members 351b are provided. The two second separation locking members 351b are symmetrically distributed with respect to the rotation axis R of the connecting base 32. The two second separation locking members 351b and the two first separation locking members 351a are spaced apart. Each first separation locking member 351a is arranged at an angle with the adjacent second separation locking member 351b, and the angle is approximately 90 degrees. That is, the angle between the first moving direction DM1 and the second moving direction DM2 is 90 degrees. In other unillustrated embodiments, at least two separation locking members 351, such as two, three, five, six or the like, may be provided. The at least two separation locking members 351 are evenly arranged around the third groove 323 (See FIG. 40), so that the force received when the connecting base 32 and the movable base 33 are engaged is more balanced. The at least two separation locking members 351 may include only two first separation locking members 351a, or only include at least two second separation locking members 351b. Alternatively, the at least two locking members include one first separation locking member 351a and at least one second separation locking member 351b, or one second separation locking member 351b and at least one first separation locking member 351a, and which is not limited thereto in this application.

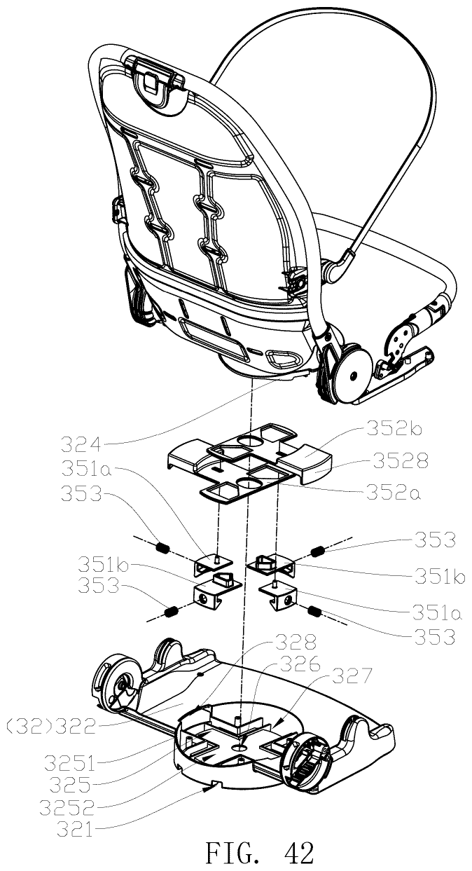

As shown in FIGS. 39, 41, and 43, the separation unlocking member 352 includes a first separation unlocking member 352a and a second separation unlocking member 352b. The unlocking driving surface 3523 includes a first unlocking driving surface 3523a and a second unlocking driving surface 3523b. The first separation unlocking assembly 352a includes a first unlocking driving surface 3523a. The second separation unlocking member 352b includes a second unlocking driving surface 3523b. The first separation unlocking member 352a and the second separation unlocking member 352b are symmetrically distributed with respect to the rotation axis R. The first separation unlocking member 352a and the second separation unlocking member 352b have exactly the same configuration. For convenience of illustration, the first separation unlocking member 352a is taken as an example for description. A second groove 3252 (see FIG. 42) is further disposed on the bottom wall of the receiving chamber 325 of the connecting base 32. The second groove 3252 is a cross-shaped groove. The two separation unlocking members 352 are both accommodated in the second groove 3252 and are movable along the second groove 3252, thereby defining the moving directions of the two separation unlocking members 352 and limiting their movements of the two separation unlocking members 352.

As shown in FIGS. 41 to 43, the first separation unlocking member 352a includes a separation driving member 3525 and a separation operating part 3526. The connecting base 32 is provided with a second opening 328 extending through the receiving chamber 325. The separation operating part 3526 extends through the second opening 328 and extends out of the receiving chamber 325, so as to be operated. The separation operating part 3526 is provided with an operation end part 3528. The operation end part 3528 extends from the separation operating part 3526 and extends in a direction away from the seat assembly 2 to facilitate grasping and operating the separation operating part 3526. Referring to FIG. 41, in some embodiments, the separation operating part 3526 is further provided with an operation hole 3527, so that the separation operating part 3526 is more convenient to be grasped. The separation driving member 3525 is located in the receiving chamber 325. When the separation operating part 3526 is operated, the separation operating part 3526 can drive the separation driving member 3525 to move in the receiving chamber 325. The moving direction of the separation unlocking member 352 is parallel to the first moving direction DM1. A boss 329 is provided in the receiving chamber 325. The boss 329 and the first insertion hole 326 are coaxially arranged. The first separation unlocking member 352a is provided with a second insertion hole 3524. The second insertion hole 3524 has a substantially elliptical cross-section. The boss 329 is inserted into the second insertion hole 3524, to limit the movement of the separation unlocking member 352. The first separation unlocking member 352a is generally “T” shaped.

Further, as shown in FIGS. 41 and 43, the first separation unlocking member 352a is provided with a first driving groove 3521 and a second driving groove 3522a. The first protrusion 3513 of the first separation locking member 351a is inserted into the first driving groove 3521 and can move along the first driving groove 3521. The extending direction of the first driving groove 3521 is parallel to the first moving direction DM1. The groove wall of the second driving groove 3522a forms a first unlocking driving surface 3523a. The first unlocking driving surface 3523a is arranged at an angle such as 45 degrees with the second moving direction DM2, and is arranged at an angle such as 45 degrees with the first moving direction DM1. The second protrusion 3514 of the second separation locking member 351b is inserted into the second driving groove 3522a. The unlocking driving surface 3523 is adapted to abut against the locking driving surface 3515, to drive the second separation locking member 351b to move in the second moving direction DM2. Two second driving grooves 3522a are provided. The two second driving grooves 3522a are symmetrically distributed about the rotation axis R. Correspondingly, two first unlocking driving surfaces 3523a are provided. The two first unlocking driving surfaces 3523a are both disposed on the separation driving member 3525 of the first separation unlocking member 352a, and symmetrically distributed with respect to the second insertion hole 3524. The first separation unlocking member 352a is drivingly connected to the two second separation locking members 351b respectively by the two second driving grooves 3522a. Similarly, the second separation unlocking member 352b is provided with two second driving grooves 3522b. The groove wall of each second driving groove 3522a forms a second unlocking driving surface 3523b. The second separation unlocking member 352b is drivingly connected to the two second separation locking members 351b respectively by two second driving grooves 3522a. Specifically, each first unlocking driving surface 3523a abuts against the corresponding first locking driving surface 3515a of the second separation locking member 351b, and each second unlocking driving surface 3523b of the second separation locking member 352b abuts against the corresponding second locking driving surface 3515b of the second separation locking member 351b.

Referring to FIG. 41, the separation driving member 3525 of the first separation unlocking member 352a at least partially overlaps the separation driving member 3525 of the second separation unlocking member 352b. The first unlocking driving surface 3523a is arranged at an angle with the corresponding second unlocking driving surface 3523b. For example, the first unlocking driving surface 3523a and the corresponding second unlocking driving surface 3523b are arranged at an included angle of 90 degrees. The second protrusion 3514 of each second separation locking member 351b is inserted into both the corresponding second driving groove 3522a of the first separation unlocking member 352a and the corresponding second driving groove 3522b of the second separation unlocking member 352b. The first locking driving surface 3515a of each second separation locking member 351b abuts against the corresponding first unlocking driving surface 3523a of the first separation unlocking member 352a. The second locking driving surface 3515b of each second separation locking member 351b abuts against the corresponding second unlocking driving surface 3523b of the second separation unlocking member 352b. That is, each second separation locking member 351b is drivingly connected to the first separation unlocking member 352a and the second separation unlocking member 352b, so that when the first separation unlocking member 352a and the second separation unlocking member 352b move away from or approach each other, the corresponding second separation locking member 351b is driven to move in the second moving direction DM2. As such, the second separation locking member 351b can move in the second moving direction DM2 more smoothly. In some other unillustrated embodiments, one of the two second separation locking members 351b may be drivingly connected to the first separation unlocking member 352a, and the other of the two second separation locking members 351b may be connected to the second separation unlocking member 352b.

In an embodiment, as shown in FIGS. 39 and 43, the separation reset member 353 is disposed between the separation locking member 351 and the connecting base 32. The separation reset member 353 is adapted to bias the separation locking member 351 to move towards the separate locked position. The separation reset member 353 includes elastic members such as springs and elastic pieces. In this embodiment, the separation reset member 353 is a compression spring. The separation reset member 353 is accommodated in the receiving chamber 325. A first end of the separation reset member 353 abuts against the sidewall 3251 of the receiving chamber 325, and a second end of the separation reset member 353 abuts against the separation locking member 351. The number of separation reset members 353 corresponds to the number of separation locking members 351, so that each separation reset member 353 can bias the corresponding separation locking member 351 to move towards the separation locked position, thereby driving the corresponding separation unlocking member 352 to move towards the initial position before being operated. In some other unillustrated embodiments, the number of separation reset members 353 may be less than the number of separation locking members 351. For example, four separation locking members 351 may be provided, and two separation reset members 353 may be provided. The two separation reset members 353 respectively bias one of the adjacent first separation locking members 351a and one of the adjacent second separation locking members 351b to move towards the separation locked position, thereby driving the corresponding separation unlocking component 352 to move towards the initial position before being operated, and thereby driving the other of the adjacent first separation locking members 351a and the other of the adjacent second separation locking members 351b to move towards the separation locked position by virtue of the driving connection between the separation locking component 351 and the separation unlocking assembly 352.

The principle of disassembly and assembly of the seat assembly 2 in the embodiment of the present application is as follows.

When it is necessary to remove the seat assembly 2, as shown in FIG. 41, the first separation unlocking member 352a and the second separation unlocking member 352b are pulled simultaneously, that is, the first separation unlocking member 352a and the second separation unlocking member 352a are operated to move away from each other in the direction DM1. During such process, with the first protrusion 3513 inserted into the first driving groove 3521, the two first separation locking members 351a are driven to move away from each other in the first moving direction DM1, so that the hook parts 3511 of the two first separation locking members 351a are respectively separated from the engaging grooves 331 of the movable base 33 (see FIG. 38). Moreover, since each first unlocking driving surface 3523a of the first separation unlocking member 352a abuts against the corresponding first locking driving surface 3515a of the first separation locking member 351a, and each second unlocking driving surface 3523b of the second separation unlocking member 352b abuts against the second locking driving surface 3515b of the corresponding first separation locking member 351a, the two second separation locking members 351b can be driven to move away from each other in the second moving direction DM2, so that the hook parts 3511 of the two second separation locking members 351b are respectively separated from the engaging grooves 331, thereby realizing the separation of the connecting base 32 from the movable base 33, and further realizing the separation of the seat assembly 2 from the frame 1. During the disassembly of the seat assembly 2, there is no need to operate the reversing unlocking member 341.

When it is necessary to mount the seat assembly 2 to the frame 1, as shown in FIGS. 38 and 39, the connecting base 32 and the movable base 33 are brought close to each other so that the movable base 33 is at least partially accommodated in the third recess 323 of the connecting base 32. During such process, the movable base 33 pushes against the wedge-shaped surface 3512 of the separation locking member 351 to drive the separation locking member 351 to move from the separation locked position to the separation unlocked position. in this case, the disc-shaped part 335 of the movable base 33 can move along the wedge-shaped surface 3512, and cross over the hook part 3511 to be between the hook part 3511 and the base of the third groove 323. When the movable base 33 is separated from the wedge-shaped surface 3512, the movable base 33 does not push against the wedge-shaped surface 3512, and thus the separation locking member 351 which is not pushed by the movable base 33 can move towards the separation locked position, and be automatically engaged with the engaging groove 331, under the elastic force of the separation reset member 353. Thus, the connecting base 32 and the movable base 33 are connected to each other, and the seat assembly 2 is mounted on the frame 1.

The stroller of this application has at least the following technical effects.

The stroller of the present application includes the above-mentioned frame 1. The above-mentioned frame 1 can drive the first wheel frame 100, the second wheel frame 200 and the push rod frame 400 to rotate and fold by the folding mechanism 500, which facilitates storage and portability. The handle part 423 of the push rod frame 400 is drivingly connected to the unlocking assembly 520 of the folding mechanism 500, so that the user does not need to bend down when folding the frame 1, and the operation is simple and fast.

The stroller of the present application includes the seat locking device 3. By switching the first locking mechanism 34 between the unlocked state and the locked state, the connecting base 32 or the seat assembly 2 can move or fixed relative to the seat frame 31. When the first locking mechanism 34 is in the locked state, the connecting base 32 is in the first moving position and cannot move or rotate relative to the seat frame 31. When the first locking mechanism 34 is in the unlocked state, the connecting base 32 can move between the first moving position and the second moving position. When the connecting base 32 moves to the second moving position, the connecting base 32 is rotatable relative to the seat frame 31, so that the connecting base 32 together with the seat assembly 2 can rotate to the desired angle. In this case, the connecting base 32 can be moved to the first moving position, so that the connecting base 32 cannot rotate relative to the seat frame 31, thereby fixing the connecting base 32 at the desired angle, and thereby fixing the seat assembly 2 at the desired angle. The reversing process of the stroller and the seat locking device 3 is simple and easy to operate and implement.

In the stroller including the seat locking device 3 of the present application, the connecting base 32 and the seat frame 31 can be mounted to each other or detached from each other very conveniently by simply operating the second locking mechanism 35. It can not only meet the reversing needs of the stroller, but also meet the needs of separating the seat assembly 2 from the frame 1 of the stroller. The second locking mechanism 35 has a simple configuration and is easy to operate.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various variants and improvements can be made without departing from the concept of the present disclosure, and all fall within the protection scope of the present disclosure. Therefore, the patent protection of the present disclosure shall be subjected to the appended claims.

1-19. (canceled)

20. A frame, comprising:
a first wheel frame including a first support assembly;
a second wheel frame including a second support assembly;
a push rod frame including a push rod assembly; and
a folding mechanism including a linkage assembly and a rotating shaft;
wherein the first support assembly and the second support assembly, and the push rod assembly are pivotally connected through the rotating shaft; and the first support assembly and the second support assembly are capable of being rotated and folded relative to the push rod assembly through the linkage assembly.

21. The frame according to claim 20, wherein the linkage assembly includes:
a first linking rod, a first end of the first linking rod being rotatably connected to the push rod assembly;
a second linking rod, a first end of the second linking rod being rotatably connected to a second end of the first linking rod, and a second end of the second linking rod being rotatably connected to the first support assembly; and
a third linking rod, a first end of the third linking rod being rotatably connected to the second end of the first linking rod, and a second end of the third linking rod being rotatably connected to the second support assembly.

22. The frame according to claim 20, wherein the linkage assembly includes:
a sun gear fixed to the push rod assembly;
a rotary plate fixed to the first support assembly and including a first guide groove, the first guide groove including a toothed edge;
a planetary gear engaged with the sun gear and the toothed edge; and
a driving shaft arranged eccentrically with respect to the rotating shaft;
wherein the driving shaft extends through the second support assembly, the planetary gear, and the push rod assembly; and the second support assembly is pivotally connected to the push rod assembly by the driving shaft.

23. The frame according to claim 22, wherein the driving shaft is fixedly connected to the second support assembly and the planetary gear, and rotatable relative to the push rod assembly.

24. The frame according to claim 22, wherein the toothed edge is arc-shaped, and is arranged along a circumferential direction of the rotary plate; and/or
the toothed edge includes a first end and a second end, for limiting movement of the planet gear between the first end and the second end.

25. The frame according to claim 20, wherein the first support assembly includes a first rotating base; the second support assembly includes a second rotating base; and the push rod assembly includes a pivot base;
wherein the first rotating base, the second rotating base and the pivot base are pivotally connected through the rotating shaft.

26. The frame according to claim 20, wherein the first wheel frame includes two first support assemblies opposite to each other; the second wheel frame includes two second support assemblies opposite to each other; the two first support assemblies, the two second support assemblies, and the push rod assembly are pivotally connected by the rotating shaft;
the folding mechanism includes two linkage assemblies; each first support assembly and each second support assembly are movably connected to the push rod assembly by the respective linkage assembly; and each first support assembly and each second support assembly are capable of being rotated and folded relative to the push rod assembly by the respective linkage assembly.

27. The frame according to claim 26, wherein each first support assembly includes a first rotating base; each second support assembly includes a second rotating base; the push rod assembly includes a pivot base;
two first rotating bases are pivotally connected to two sides of the pivot base respectively; and two second rotating bases are pivotally connected to sides of the two first rotating bases away from the pivot base by the rotating shaft respectively.

28. The frame according to claim 20, wherein the push rod frame further includes a handle assembly; the folding mechanism further includes an unlocking assembly;
wherein the handle assembly is drivingly connected to the unlocking assembly; and the unlocking assembly is operable to drive the unlocking assembly to be unlocked, so that the first support assembly and the second support assembly are capable of being rotated and folded relative to the push rod assembly through the linkage assembly.

29. The frame according to claim 28, wherein the first support assembly includes a first rotating base including a locking recess; the unlocking assembly includes a locking member;
when the locking member is in a locked state, the locking member is inserted into the locking recess, so that the push rod assembly and the first support assembly are fixed relative to each other; when the unlocking assembly is in an unlocked state, the locking member is separated from the locking recess so that the push rod assembly is rotatable relative to the first support assembly; and/or
the unlocking assembly further includes:
a driving member disposed on the push rod assembly, and drivingly connected to the handle assembly; and
a pulling member, two ends of the pulling member being connected to the driving member and the locking member respectively;
wherein the handle assembly is operable to drive the driving member to move, and drive the locking member to be separated from the locking recess by the pulling member.

30. The frame according to claim 29, wherein the handle assembly includes a handle body and a handle part rotatably disposed on the handle body; and the driving member is connected to the handle part and is rotatable with the handle part; and/or
the unlocking assembly further includes a safety unlocking member movable between a first position and a second position, wherein when the safety unlocking member is in the first position, the handle part is unable to drive the driving member to move when being operated; when the safety unlocking member is in the second position, the handle part is able to drive the driving member to move when being operated; and/or
the unlocking assembly further includes a limiting member movably disposed on the push rod frame, wherein when the safety unlocking member is in the first position, the limiting member limits a movement of the driving member; when the safety unlocking member is in the second position, the limiting member does not limit the movement of the driving member, and the safety unlocking member is operable to move from the first position to the second position.

31. A stroller, comprising:
the frame according to claim 20;
a seat frame disposed on the push rod frame; and
a seat assembly disposed on the seat frame.

32. The stroller according to claim 31, wherein the seat frame is movable along the push rod assembly; and
the stroller further includes a seat height adjustment mechanism disposed between the push rod frame and the seat frame, wherein the seat height adjustment mechanism has a locked state and an unlocked state;
when the seat height adjustment mechanism is in the locked state, the seat frame and the push rod assembly are fixed relative to each other; when the seat height adjustment mechanism is in the unlocked state, the seat frame is movable relative to the push rod assembly so that a height of the seat assembly is adjustable.

33. The stroller according to claim 31, further comprising: a seat height adjustment mechanism disposed between the push rod frame and the seat frame, the seat height adjustment mechanism including:
a plurality of first locking holes disposed in the push rod assembly; and
a first locking pin disposed on the seat frame, and the first locking pin being movable between a third position and a fourth position;
wherein the first locking pin is inserted into one of the first locking holes when being in the third position, and the first locking pin is separated from the first locking hole when being in the fourth position; and/or
the seat height adjustment mechanism further includes a height adjustment operating member including:
a pivot end pivotally connected to the first locking pin; and
an operating end operable to drive the first locking pin to move towards the fourth position by the pivot end.

34. The stroller according to claim 31, wherein a length of the push rod assembly is adjustable; and/or
the stroller further includes a length adjustment mechanism; the push rod assembly includes a first push rod and a second push rod; the first push rod is at least partially inserted into the second push rod;
wherein the length adjustment mechanism includes:
a plurality of second locking holes disposed on the second push rod; and
a second locking pin disposed on the first push rod and movable between a fifth position and a sixth position;
wherein when the second locking pin is in the fifth position, the second locking pin is inserted into one of the second locking holes, and when the second locking pin is in the sixth position, the second locking pin is separated from the second locking hole; and/or
wherein the length adjustment mechanism includes a length adjustment operating member disposed on the first push rod and drivingly connected to the second locking pin, wherein the length adjustment operating member is operable to drive the second locking pin to move towards the sixth position.

35. The stroller according to claim 31, further comprising:
a connecting base disposed on the seat assembly and movably connected to the seat frame, the connecting base having a first moving position and a second moving position, wherein when the connecting base is in the first moving position, the connecting base is not rotatable relative to the seat frame, and when the connecting base is in the second moving position, the connecting base is rotatable relative to the seat frame; and
a first locking mechanism switchable between an unlocked state and a locked state;
wherein when the first locking mechanism is in the unlocked state, the connecting base is movable between the first moving position and the second moving position relative to the seat frame; when the first locking mechanism is in the locked state, the connecting base is not movable relative to the seat frame.

36. The stroller according to claim 35, wherein the seat frame is provided with a guide rail, and a first guide groove is disposed on a side of the connecting base facing the seat frame; the connecting base is capable of moving along the guide rail between the first moving position and the second moving position through an engagement between the first guide groove with the guide rail;
when the connecting base is in the first moving position, the first guide groove is engaged with the guide rail, so that the connecting base is not rotatable relative to the seat frame; when the connecting base is in the second moving position, the first guide groove is disengaged from the guide rail, so that the connecting base is rotatable relative to the seat frame.

37. The stroller according to claim 36, wherein the first locking mechanism includes a reversing unlocking member operably disposed between the seat frame and the connecting base, wherein the reversing unlocking member is switchable between a reversal unlocked position and a reversal locked position;
wherein when the reversing unlocking member is in the reversal locked position, the reversing unlocking member abuts against the guide rail, so that the reversing unlocking member is not movable along the guide rail, and limits a movement of the connecting base along the guide rail; when the reversing unlocking member is in the reversing unlocked position, the reversing unlocking member is movable along the guide rail, so that the connecting base is movable relative to the seat frame.

38. The stroller according to claim 37, wherein the guide rail includes a switching notch; and when the connecting base is in the first moving position, the reversing unlocking member is inserted into the switching notch, and the reversing unlocking member moves relative to the guide rail in a direction intersecting with an extending direction of the guide rail to switch between the reversing unlocked position and the reversing locked position.

39. The stroller according to claim 37, wherein the reversing unlocking member includes a strip-shaped positioning groove; the first locking mechanism further includes a positioning pin;
wherein the positioning pin is capable of being inserted into the positioning groove, so that the reversing unlocking member is movable relative to the positioning pin in a direction intersecting with an extending direction of the guide rail, and is movable along the extending direction of the guide rail in synchronization with the positioning pin.
